(19) United States
(12) Patent Application Publication
(10) Pub. No.: US 2015/0261113 A1
(43) Pub. Date: Sep. 17, 2015

(54) TONER, DEVELOPER, AND IMAGE FORMING APPARATUS

(71) Applicants: Akihiro Takeyama, Kanagawa (JP); Shinya Nakayama, Shizuoka (JP); Hiroshi Yamada, Shizuoka (JP); Minoru Masuda, Shizuoka (JP); Akinori Saito, Shizuoka (JP); Hideyuki Santo, Kanagawa (JP); Ryuta Chiba, Kanagawa (JP); Hiroyuki Takeda, Kanagawa (JP)

(72) Inventors: Akihiro Takeyama, Kanagawa (JP); Shinya Nakayama, Shizuoka (JP); Hiroshi Yamada, Shizuoka (JP); Minoru Masuda, Shizuoka (JP); Akinori Saito, Shizuoka (JP); Hideyuki Santo, Kanagawa (JP); Ryuta Chiba, Kanagawa (JP); Hiroyuki Takeda, Kanagawa (JP)

(21) Appl. No.: 14/629,934

(22) Filed: Feb. 24, 2015

(30) Foreign Application Priority Data
Mar. 14, 2014 (JP) 2014-052694

(51) Int. Cl. G03G 9/00

(52) U.S. Cl. CPC G03G 9/09766; G03G 9/08733

(57) ABSTRACT

A toner, wherein the toner satisfies a ratio XPS (%)/CIC (ppm) of 1.40×10⁻² or less, where CIC (ppm) denotes a fluorine content ratio (ppm) determined by combustion ion chromatography and XPS (%) denotes a fluorine content ratio (%) determined by X-ray photoelectron spectroscopic analysis.

### BACKGROUND OF THE INVENTION

1. Field of the Invention

The present invention relates to a toner, a developer, and an image forming apparatus.

2. Description of the Related Art

In recent years, toners have been required to have smaller particle diameters and hot offset resistance for increasing quality of output images, to have low temperature fixing ability for energy saving, and to have heat resistant storage stability for the toners to be resistant to high-temperature, high-humidity conditions during storage and transportation after production. In particular, improvement in low temperature fixing ability is very important because power consumption in fixing occupies much of power consumption in an image forming step.

Conventionally, toners produced by the kneading pulverizing method have been used. In the toners produced by the kneading pulverizing method, difficulty is encountered in making them have smaller particle diameters, and their shapes are indefinite and their particle size distribution is broad, for which these toners have the following problems, for example: the quality of output images is not sufficient; and the fixing energy required is high. Also, when wax (release agent) has been added for improving fixing ability, the toners produced by the kneading pulverizing method are cracked upon pulverization at the interfaces with the wax, so that much of the wax is disadvantageously present on the toner surface. As a result, although releasing effects can be obtained, deposition (filming) of the toners on carriers, photoconductors, and blades will easily occur. Thus, their entire performances have not been satisfactory, which is problematic.

Then, in order to overcome the above problems accompanied by the kneading pulverizing method, toner production methods based on the polymerization method have been proposed. Toners produced by the polymerization method are easily allowed to have smaller particle diameters, and their particle size distribution is sharper than that of the toners produced by the pulverization method and moreover it is possible to enclose the release agent. In one disclosed toner production method based on the polymerization method, toners are produced from elongated reaction products of urethane-modified polyesters serving as a toner binder for the purpose of improving the low temperature fixing ability and hot offset resistance (see, for example, Japanese Patent Application Laid-Open (JP-A) No. 11-133665).

In addition, there are disclosed production methods for toners excellent in powder flowability and transferability when they are formed to have smaller particle diameters, as well as in all of heat resistant storage stability, low temperature fixing ability, and hot offset resistance (see, for example, JP-A Nos. 2002-287400 and 2002-351143).

Further, there are disclosed production methods for toners including an aging step for producing a toner binder having a stable molecular weight distribution to achieve both of low temperature fixing ability and hot offset resistance (see, for example, Japanese Patent (JP-B) No. 2579150 and JP-A No. 2001-158819).

These proposed techniques, however, do not attain a high level of low temperature fixing ability that has recently been demanded.

Then, in order to attain a high level of low temperature fixing ability, there are proposed toners containing a resin including a crystalline polyester resin, and a release agent and having a phase separation structure which is a sea-island form where the resin and wax are incompatible to each other (see, for example, JP-A No. 2004-46095).

Also, there is proposed a toner containing a crystalline polyester resin, a release agent, and a graft polymer (see, for example, JP-A No. 2007-271789).

According to these proposed techniques, the crystalline polyester resin more rapidly melts than a non-crystalline polyester resin does, which makes it possible to attain lower fixing. Nonetheless, even if the crystalline polyester resin, which corresponds to the islands in the sea-island phase separation structure, melts, the non-crystalline polyester resin, which corresponds to the sea occupying much area of the structure, does not yet melt. As a result, since the toner is not fixed unless both of the crystalline polyester resin and the non-crystalline polyester resin melt to some extents, these proposed techniques do not attain a high level of low temperature fixing ability that has recently been demanded.

Regarding charging properties of the toner, it is also known to incorporate fluorine compounds serving as a charge controlling agent or the like into pulverized toners as a method for increasing charging ability of especially negatively charged toners (see, for example, JP-B Nos. 2942588 and 3102797). This method, however, does not exhibit sufficient improving effects of charge rising properties, which causes problematic toner's background smear (fogging) and toner scattering. Moreover, there is a problem in terms of charging stability to environmental factors.

Many of the compounds used as a charge controlling agent have polarity. When such a charge controlling agent is internally added and used in granulation by aqueous emulsification using an aqueous phase and an oil phase, the charge controlling agent often elutes to the aqueous phase depending on affinity to and solubility in the oil phase and aqueous phase, which makes it substantially difficult to internally add the charge controlling agent to toners granulated in an aqueous system (see JP-B No. 3069936).

Besides, there are disclosed toners which have high charging performances attained by externally adding a fluorine compound in a wet system to attach it to the toner surface, and which have a sharp charge amount distribution and contain a less amount of weakly charged and/or oppositely charged toner (see, for example, JP-A No. 2005-115213). This method, however, has a problem that the charge amount of the resultant toner decreases over time as a result of long-term stirring with carriers. JP-A No. 2005-115213 also discloses a toner containing a fluorine compound, which is dispersed in an aqueous medium during production. Also in this method, however, the charge amount of the resultant toner decreases over time.

Further, there are proposed toners formed of spherical toner particles having a fluorine atom in surface layers thereof so that an atomic ratio of fluorine/carbon is in the range of 0.01 to 1.00 (see, for example, JP-A No. 01-235959). This proposed technique, however, does not provide a toner having all of excellent low temperature fixing ability, excellent heat resistant storage stability, and excellent charging stability.

Accordingly, at present, demand has arisen for a toner having all of excellent low temperature fixing ability, excellent heat resistant storage stability, and excellent charging stability.

### SUMMARY OF THE INVENTION

The present invention aims to solve the above problems pertinent in the art and achieve the following object.

That is, an object of the present invention is to provide a toner having all of excellent low temperature fixing ability, excellent heat resistant storage stability, and excellent charging stability.

Means for solving the above problems are as follows.

That is, a toner of the present invention satisfies a ratio XPS (%)/CIC (ppm) of 1.40×10⁻² or less, where CIC (ppm) denotes a fluorine content ratio (ppm) determined by combustion ion chromatography and XPS (%) denotes a fluorine content ratio (%) determined by X-ray photoelectron spectroscopic analysis.

According to the present invention, it is possible to solve the above problems pertinent in the art and provide a toner having all of excellent low temperature fixing ability, excellent heat resistant storage stability, and excellent charging stability.

### BRIEF DESCRIPTION OF THE DRAWINGS

FIG. 1 is a schematic structural view of one example of an image forming apparatus of the present invention.

FIG. 2 is a schematic structural view of another example of an image forming apparatus of the present invention.

FIG. 3 is a schematic view of one configuration of an image-forming portion of the image forming apparatus illustrated in FIG. 2.

FIG. 4 is schematic structural view of one example of a process cartridge concerning the present invention.

### DETAILED DESCRIPTION OF THE INVENTION

### (Toner)

A toner of the present invention satisfies a ratio XPS (%)/CIC (ppm) of 1.40×10⁻² or less, where CIC (ppm) denotes a fluorine content ratio (ppm) determined by combustion ion chromatography and XPS (%) denotes a fluorine content ratio (%) determined by X-ray photoelectron spectroscopic analysis.

The ratio XPS (%)/CIC (ppm) is 1.40×10⁻² or less, preferably 0.60×10⁻² to 1.40×10⁻², more preferably 0.80×10⁻² to 1.20×10⁻². When the ratio XPS (%)/CIC (ppm) is more than 1.40×10⁻², fluorine-containing components attached on the toner surface (e.g., fluorine-containing compounds) inhibit fixing to degrade low temperature fixing ability. The ratio XPS (%)/CIC (ppm) can be controlled based on the structure of a fluorine-containing component contained in the toner (e.g., a fluorine-containing compounds as a charge controlling agent). For example, when the fluorine-containing compound used is highly lipophilic, the fluorine-containing compound becomes easily enclosed inside the toner, so that the ratio XPS (%)/CIC (ppm) becomes small. Note that, the larger ratio XPS (%)/CIC (ppm) means that the fluorine-containing components in the toner are localized in the toner surface, and the smaller ratio XPS (%)/CIC (ppm) means that the fluorine-containing components in the toner are localized in the interior of the toner. Note that, the ratio XPS (%)/CIC (ppm) of 1.00×10⁻² does not necessarily mean that the fluorine-containing components are uniformly distributed in the toner.

The fluorine content ratio determined by combustion ion chromatography (CIC) (ppm) is not particularly limited and may be appropriately selected depending on the intended purpose, but is preferably 450 to 700, more preferably 500 to 600. The fluorine content ratio (CIC) (ppm) falling within the above more preferred range is advantageous in terms of charging stability and low temperature fixing ability.

The fluorine content ratio determined by X-ray photoelectron spectroscopic analysis (XPS) (%) is not particularly limited and may be appropriately selected depending on the intended purpose, but is preferably 2.0 to 8.0, more preferably 4.0 to 6.0. When the fluorine content ratio (XPS) (%) falling within the above more preferred range is advantageous in terms of charge rising properties (TA15).

### <Fluorine-Containing Compound>

The fluorine-containing compound usable in the toner is not particularly limited and may be appropriately selected depending on the intended purpose, but is preferably nonionic. The fluorine-containing compound that is nonionic is not particularly limited and may be appropriately selected depending on the intended purpose, but preferably has a polyoxyethylene ether structure.

The fluorine-containing compound can be used as a charge controlling agent. Hereinafter, the fluorine-containing compound may be referred to as a charge controlling agent.

The fluorine-containing compound has a hydrophobic group attributed to fluorine. Therefore, it is easily attached in the vicinity of the toner surface. The hydrophobic group is preferably a perfluoroalkenyl group. Meanwhile, the fluorine-containing compound is also enclosed in the interior of the toner because of lipophilic properties of the polyoxyethylene ether structure. Therefore, use of the fluorine-containing compound having a polyoxyethylene ether structure enables the ratio XPS (%)/CIC (ppm) to easily be adjusted to fall within the suitable range over which the effects of the present invention are obtained.

Note that, when the fluorine-containing compound is highly hydrophobic, it becomes difficult to produce a toner having a ratio XPS (%)/CIC (ppm) of 1.40×10⁻² or less.

When the fluorine-containing compound has a cationic polar group or an anionic polar group, its dispersibility in an oil phase in the toner production is insufficient, which may make it difficult for the fluorine-containing compound to be enclosed.

Commercially available products of the fluorine-containing compound having a polyoxyethylene ether structure include FTERGENT 209F, FTERGENT 212P, FTERGENT 220P, and FTERGENT 710FM (products of NEOS COMPANY LIMITED). Note that, the effects of the present invention are not limited by properties of the fluorine-containing compound such as purity, pH, and pyrolysis temperature.

The amount of the fluorine-containing compound in the toner is not particularly limited and may be appropriately selected depending on the intended purpose, but is preferably 0.05% by mass to 0.20% by mass, more preferably 0.1% by mass to 0.15% by mass. When the amount thereof is less than 0.05% by mass, sufficient charge amount cannot be obtained, and the effects of the present invention may not sufficiently be obtained. When it is more than 0.20% by mass, the resultant developer may have failure to be fixed.

The toner is preferably obtained by removing an aqueous solvent from a dispersion liquid obtained by dispersing, in the aqueous solvent, a solution or dispersion containing a toner composition containing a binder resin, resin particles, and the above charge controlling agent.

In the case of the toner whose surface has been treated with a fluorine compound as in the conventional toners, the fluorine compound is preferentially added to organic resin particles present in the vicinity of the toner surface, and the fluorine compound itself is localized in the toner surface to play a role as a charge controlling agent. In this case, however, abrasion and/or cracking of the toner surface due to stirring with carrier results in disappearance from the toner of the fluorine compound serving as a charge controlling agent, leading to a drop in charge amount.

The charge controlling agent used in the toner of the present invention is preferably soluble or dispersible in an organic solvent, and by using the charge controlling agent having such properties, it is possible to enclose the charge controlling agent in the interior of the toner by adding charge controlling agent during toner granulation. When the charge controlling agent is enclosed in the interior of the toner, a stable charge amount can be obtained even when abrasion and/or cracking of the toner surface due to stirring with carrier occur(s).

The toner preferably contains a polyester resin, and if necessary further contains other components.

The polyester resin is not particularly limited and may be appropriately selected depending on the intended purpose, but preferably contains at least one of a crystalline polyester resin (hereinafter may be referred to as “crystalline polyester resin C”) and a non-linear polyester resin having a cross-linked structure. The non-linear polyester resin having a cross-linked structure is preferably a non-crystalline polyester resin (hereinafter may be referred to as “non-crystalline polyester resin A”). The polyester resin may contain another or other non-crystalline polyester resins (hereinafter may be referred to as “non-crystalline polyester resin B”).

### <Non-Crystalline Polyester Resin A>

The non-crystalline polyester resin A is one obtained through reaction between a non-linear, reactive precursor and a curing agent.

The non-crystalline polyester resin A preferably contains at least one of a urethane bond or a urea bond since it is possible to obtain more excellent adhesion to recording media such as paper. Also, the non-crystalline polyester resin A contains at least one of a urethane bond and a urea bond, thus it behaves like pseudo-crosslinked points, and the non-crystalline polyester resin A exhibits stronger rubber-like properties, further improving heat resistant storage stability and high temperature offset resistance of the toner.

### —Non-Linear, Reactive Precursor—

The non-linear, reactive precursor is not particularly limited and may be appropriately selected depending on the intended purpose so long as it is a polyester resin containing a group reactive with a curing agent (hereinafter may be referred to as “prepolymer”).

Examples of the group reactive with the curing agent in the prepolymer include a group reactive with an active hydrogen group. Examples thereof include an isocyanate group, an epoxy group, a carboxylic acid group, and an acid chloride group. Among them, the isocyanate group is preferable because it is possible to introduce a urethane bond and/or a urea bond to the non-crystalline polyester resin A.

The prepolymer is a non-linear prepolymer. The non-linear prepolymer means a prepolymer having a branched structure provided by at least one of trihydric or more alcohol and trivalent or more carboxylic acid.

As the prepolymer, an isocyanate group-containing polyester resin is preferable.

### —Isocyanate Group-Containing Polyester Resin—

The isocyanate group-containing polyester resin is not particularly limited and may be appropriately selected depending on the intended purpose. Examples thereof include a reaction product between an active hydrogen group-containing polyester resin and a polyisocyanate. The active hydrogen group-containing polyester resin can be obtained by polycondensation of, for example, diol, dicarboxylic acid, and at least one of trihydric or more alcohol and trivalent or more carboxylic acid. The trihydric or more alcohol and the trivalent or more carboxylic acid provide the isocyanate group-containing polyester with a branched structure.

The diol is not particularly limited and may be appropriately selected depending on the intended purpose. Examples thereof include aliphatic diols such as ethylene glycol, 1,2-propylene glycol, 1,3-propylene glycol, 1,4-butanediol, 3-methyl-1,5-pentanediol, 1,6-hexanediol, 1,8-octanediol, 1,10-decanediol, and 1,12-dodecanediol; an oxyalkylene group-containing diols such as diethylene glycol, triethylene glycol, dipropylene glycol, polyethylene glycol, polypropylene glycol and polytetramethylene glycol; alicyclic diols such as 1,4-cyclohexanedimethanol and hydrogenated bisphenol A; adducts of alicyclic diols with alkylene oxides such as ethylene oxide, propylene oxide, and butylene oxide; bisphenols such as bisphenol A, bisphenol F and bisphenol S; and adducts of bisphenols with alkylene oxides such as ethylene oxide, propylene oxide, and butylene oxide. Among them, aliphatic diols having 4 to 12 carbon atoms are preferable.

These diols may be used alone or in combination thereof.

The dicarboxylic acid component is not particularly limited and may be appropriately selected depending on the intended purpose. Examples thereof include aliphatic dicarboxylic acids and aromatic dicarboxylic acids. Besides, anhydrides thereof, lower (C1-C3) alkyl-esterified compounds thereof, or halides thereof may also be used.

The aliphatic dicarboxylic acid is not particularly limited and may be appropriately selected depending on the intended purpose. Examples thereof include succinic acid, adipic acid, sebacic acid, decanedioic acid, maleic acid, and fumaric acid.

The aromatic dicarboxylic acid is not particularly limited and may be appropriately selected depending on the intended purpose. Examples thereof preferably include an aromatic dicarboxylic acid having 8 to 20 carbon atoms. Examples the aromatic dicarboxylic acid having 8 to 20 carbon atoms include phthalic acid, isophthalic acid, terephthalic acid, and naphthalenedicarboxylic acids.

Among them, aliphatic dicarboxylic acids having 4 to 12 carbon atoms are preferable.

These dicarboxylic acids may be used alone or in combination thereof.

### ———Trihydric or More Alcohol———

The trihydric or more alcohol is not particularly limited and may be appropriately selected depending on the intended purpose. Examples thereof include trivalent or higher aliphatic alcohol, trivalent or higher polyphenols, and alkylene oxide adduct of trivalent or higher polyphenols.

Examples of the trivalent or higher aliphatic alcohol include glycerin, trimethylolethane, trimethylolpropan, pentaerythritol, and sorbitol.

Examples of the trivalent or higher polyphenols include trisphenol PA, phenol novolak, cresol novolak.

Examples of the alkylene oxide adduct of trivalent or higher polyphenols include adducts of trivalent or higher polyphenols with alkylene oxide such as ethylene oxide, propylene oxide, and butylene oxide.

### ———Trivalent or More Carboxylic Acid———

The trivalent or more carboxylic acid is not particularly limited and may be appropriately selected depending on the intended purpose. Examples thereof include trivalent or more aromatic carboxylic acid. Alternatively, anhydrides thereof, lower (C1-C3) alkyl ester compounds thereof, or halides thereof may also be used.

As the trivalent or more aromatic carboxylic acid, trivalent or more aromatic carboxylic acid having 9 to 20 carbon atoms is preferable. Examples of the trivalent aromatic carboxylic acid having 9 to 20 carbon atoms include trimellitic acid and pyromellitic acid.

### ———Polyisocyanate———

The polyisocyanate is not particularly limited and may be appropriately selected depending on the intended purpose. Examples thereof include diisocyanate, and trivalent or more isocyanate.

Examples of the diisocyanate include: aliphatic diisocyanate; alicyclic diisocyanate; aromatic diisocyanate; aromatic aliphatic diisocyanate; isocyanurate; and a block product thereof where the foregoing compounds are blocked with a phenol derivative, oxime, or caprolactam.

The aliphatic diisocyanate is not particularly limited and may be appropriately selected depending on the intended purpose. Examples thereof include tetramethylene diisocyanate, hexamethylene diisocyanate, 2,6-diisocyanatomethyl caproate, octamethylene diisocyanate, decamethylene diisocyanate, dodecamethylene diisocyanate, tetradecamethylene diisocyanate, trimethylhexane diisocyanate, and tetramethylhexane diisocyanate.

The alicyclic diisocyanate is not particularly limited and may be appropriately selected depending on the intended purpose. Examples thereof include isophorone diisocyanate, and cyclohexylmethane diisocyanate.

The aromatic diisocyanate is not particularly limited and may be appropriately selected depending on the intended purpose. Examples thereof include tolylene diisocyanate, diisocyanato diphenyl methane, 1,5-nephthylene diisocyanate, 4,4′-diisocyanato diphenyl, 4,4′-diisocyanato-3,3′-dimethyldiphenyl, 4,4′-diisocyanato-3-methyldiphenyl methane, and 4,4′-diisocyanato-diphenyl ether.

The aromatic aliphatic diisocyanate is not particularly limited and may be appropriately selected depending on the intended purpose. Examples thereof include α,α,α′,α′-tetramethylxylene diisocyanate.

The isocyanurate is not particularly limited and may be appropriately selected depending on the intended purpose. Examples thereof include tris(isocyanatoalkyl)isocyanurate, and tris(isocyanatocycloalkyl)isocyanurate.

These polyisocyanates may be used alone or in combination thereof.

### —Curing Agent—

The curing agent is not particularly limited and may be appropriately selected depending on the intended purpose so long as it can react with the non-linear, reactive precursor, and produce the non-crystalline polyester resin A. Examples thereof include an active hydrogen group-containing compound.

### ——Active Hydrogen Group-Containing Compound——

The active hydrogen group in the active hydrogen group-containing compound is not particularly limited and may be appropriately selected depending on the intended purpose. Examples thereof include a hydroxyl group (e.g., an alcoholic hydroxyl group, and a phenolic hydroxyl group), an amino group, a carboxyl group, and a mercapto group. These may be used alone or in combination thereof.

The active hydrogen group-containing compound is not particularly limited and may be appropriately selected depending on the intended purpose. Amines are preferable as the amines can form a urea bond.

The amines are not particularly limited and may be appropriately selected depending on the intended purpose. Examples thereof include diamine, trivalent or more amine, amino alcohol, amino mercaptan, amino acid, and compounds in which the amino groups of the foregoing compounds are blocked. These may be used alone or in combination thereof.

Among them, diamine, and a mixture of diamine and a small amount of trivalent or more amine are preferable.

The diamine is not particularly limited and may be appropriately selected depending on the intended purpose. Examples thereof include aromatic diamine, alicyclic diamine, and aliphatic diamine. The aromatic diamine is not particularly limited and may be appropriately selected depending on the intended purpose. Examples thereof include phenylenediamine, diethyl toluene diamine, and 4,4′-diaminodiphenylethane. The alicyclic diamine is not particularly limited and may be appropriately selected depending on the intended purpose. Examples thereof include 4,4′-diamino-3,3′-dimethyldicyclohexyl methane, diaminocyclohexane, and isophoronediamine. The aliphatic diamine is not particularly limited and may be appropriately selected depending on the intended purpose. Examples thereof include the aliphatic diamine include ethylene diamine, tetramethylene diamine, and hexamethylenediamine.

The trivalent or more amine is not particularly limited and may be appropriately selected depending on the intended purpose. Examples thereof include diethylenetriamine, and triethylene tetramine.

The amino alcohol is not particularly limited and may be appropriately selected depending on the intended purpose. Examples thereof include ethanol amine, and hydroxyethyl aniline.

The amino mercaptan is not particularly limited and may be appropriately selected depending on the intended purpose. Examples thereof include aminoethyl mercaptan, and aminopropyl mercaptan.

The amino acid is not particularly limited and may be selected depending on the intended purpose. Examples thereof include aminopropionic acid, and aminocaproic acid.

The compound where the amino group is blocked is not particularly limited and may be appropriately selected depending on the intended purpose. Examples thereof include a ketimine compound where the amino group is blocked with ketone such as acetone, methyl ethyl ketone, methyl isobutyl ketone, and an oxazoline compound.

The non-crystalline polyester resin A contains a diol component as the constituent component thereof, where the diol component preferably contains an aliphatic diol having 4 to 12 carbon atoms in an amount of 50% by mass or more, in order to lower Tg thereof and in order to easily impart a property of deforming at a low temperature.

The non-crystalline polyester resin A preferably contains an aliphatic diol having 4 to 12 carbon atoms in an amount of 50% by mass or more of the total alcohol components in order to lower Tg thereof and in order to easily impart a property of deforming at a low temperature.

The non-crystalline polyester resin A contains a dicarboxylic acid component as the constituent component thereof, where the dicarboxylic acid preferably contains an aliphatic diol having 4 to 12 carbon atoms in an amount of 50% by mass or more in order to lower Tg thereof and in order to easily impart a property of deforming at a low temperature.

A glass transition temperature of the non-crystalline polyester resin A is not particularly limited and may be appropriately selected depending on the intended purpose. It is preferably −60° C. to 0° C., more preferably −40° C. to −20° C. When the glass transition temperature thereof is less than −60° C., the flow of the toner can not be controlled at a low temperature, and heat resistant storage stability and filming resistance tend to deteriorate. When the glass transition temperature thereof is more than 0° C., the deformation of the toner with heat and pressurization during fixing may be insufficient, and thus low temperature fixing ability tends to be insufficient.

A weight average molecular weight of the non-crystalline polyester resin A is not particularly limited and may be appropriately selected depending on the intended purpose, but it is preferably 20,000 to 1,000,000 as measured by GPC (gel permeation chromatography). The weight average molecular weight thereof is a molecular weight of a reaction product where the non-linear reactive precursor is allowed to react with the curing agent. When the weight average molecular weight is less than 20,000, a resultant toner may easily flow at a low temperature. In addition, heat resistant storage stability may be impaired, and a viscosity may lower during melting the toner, which may impair high temperature offset property.

A molecular structure of the non-crystalline polyester resin A can be confirmed by solution-state or solid-state NMR, X-ray diffraction, GC/MS, LC/MS, or IR spectroscopy. Simple methods thereof include a method for detecting, as a non-crystalline polyester resin, one that does not have absorption based on δCH (out-of-plane bending vibration) of olefin at 965 cm⁻¹±10 cm⁻¹ and 990 cm⁻¹±10 cm⁻¹ in an infrared absorption spectrum.

An amount of the non-crystalline polyester resin A is not particularly limited and may be appropriately selected depending on the intended purpose, but it is preferably 5 parts by mass to 25 parts by mass, more preferably 10 parts by mass to 20 parts by mass, relative to 100 parts by mass of the toner. When the amount thereof is less than 5 parts by mass, low temperature fixing ability, and hot offset resistance of a resultant toner may be impaired. When the amount thereof is greater than 25 parts by mass, heat resistant storage stability of the toner may be impaired, and glossiness of an image obtained after fixing may be reduced. When the amount thereof is within the aforementioned more preferable range, it is advantageous to be excellent in low temperature fixing ability, hot offset resistance, and heat resistant storage stability.

### <Non-Crystalline Polyester Resin B>

The non-crystalline polyester resin B is not particularly limited and may be appropriately selected depending on the intended purpose so long as the glass transition temperature thereof is 40° C. to 80° C.

As the non-crystalline polyester resin B, a linear polyester resin is preferable.

As the non-crystalline polyester resin B, an unmodified polyester resin is preferable. The unmodified polyester resin is a polyester resin obtained by using polyhydric alcohol, and multivalent carboxylic acids such as multivalent carboxylic acid, multivalent carboxylic acid anhydride, multivalent carboxylic acid ester, or derivatives thereof, and is a polyester resin which is not modified by isocyanate compounds and the like.

Examples of the polyhydric alcohol include diol.

The diol include alkylene (having 2 to 3 carbon atoms) oxide (average addition molar number is 1 to 10) adduct of bisphenol A such as polyoxypropylene(2.2)-2,2-bis(4-hydroxyphenyl)propane, and polyoxyethylene(2.2)-2,2-bis(4-hydroxyphenyl)propane; ethylenegrycol, propylenegrycol; and hydrogenated bisphenol A, and alkylene (having 2 to 3 carbon atoms) oxide (average addition molar number is 1 to 10) adduct of hydrogenated bisphenol A.

They may be used alone or in combination thereof.

Examples of the multivalent carboxylic acid include dicarboxylic acid.

Examples of the dicarboxylic acid include: adipic acid, phthalic acid, isophthalic acid, terephthalic acid, fumaric acid, maleic acid; and succinic acid substituted by an alkyl group having 1 to 20 carbon atoms or an alkenyl group having 2 to 20 carbon atoms such as dodecenylsuccinic acid and octylsuccinic acid.

These may be used alone or in combination thereof.

The non-crystalline polyester resin B may contain at least one of a trivalent or more carboxylic acid and a trihydric or more alcohol at the end of the resin chain in order to adjust acid value and hydroxyl value.

Examples of the trivalent or more carboxylic acid include trimellitic acid, pyromellitic acid, and acid anhydride thereof.

Examples of the trihydric or more alcohol include glycerin, pentaerythritol, and trimethylolpropan.

A molecular weight of the non-crystalline polyester resin B is not particularly limited and may be appropriately selected depending on the intended purpose. However, when the molecular weight thereof is too low, heat resistant storage stability of the toner and durability against stress such as stirring in the developing unit may be deteriorated. When the molecular weight thereof is too high, viscoelasticity of the toner during melting tends to be high, which may deteriorate low temperature fixing ability. The weight average molecular weight (Mw) as measured by GPC (gel permeation chromatography) is preferably 3,000 to 10,000. The number average molecular weight (Mn) is preferably 1,000 to 4,000. Further, Mw/Mn is preferably 1.0 to 4.0.

The weight average molecular weight (Mw) is more preferably 4,000 to 7,000. The number average molecular weight (Mn) is more preferably 1,500 to 3,000. The Mw/Mn is more preferably 1.0 to 3.5.

The acid value of the non-crystalline polyester resin B is not particularly limited and may be appropriately selected depending on the intended purpose. The acid value thereof is preferably 1 mgKOH/g to 50 mgKOH/g, more preferably 5 mgKOH/g to 30 mgKOH/g. When the acid value is 1 mgKOH/g or more, a resultant toner is likely to be negatively charged. In addition, a resultant toner has good affinity between the paper and the toner when fixed on the paper, which may improve low temperature fixing ability. Meanwhile, when the acid value is more than 50 mgKOH/g, a resultant toner may deteriorate charging stability, especially charging stability against environmental change.

The hydroxyl value of the non-crystalline polyester resin B is not particularly limited and may be appropriately selected depending on the intended purpose. The hydroxyl value thereof is preferably 5 mgKOH/g or more.

A glass transition temperature (Tg) of the non-crystalline polyester resin B is preferably 40° C. to 80° C., more preferably 50° C. to 70° C. When the glass transition temperature is less than 40° C., heat resistant storage stability of the toner and durability against stress such as stirring in the developing unit may be deteriorated. In addition, filming resistance of the toner may be deteriorated. Meanwhile, when the glass transition temperature is more than 80° C., the deformation of the toner with heat and pressurization during fixing may be insufficient, which may lead to insufficient low temperature fixing ability.

A molecular structure of the non-crystalline polyester resin B can be confirmed by solution-state or solid-state NMR, X-ray diffraction, GC/MS, LC/MS, or IR spectroscopy. Simple methods thereof include a method for detecting, as a non-crystalline polyester resin, one that does not have absorption based on δCH (out-of-plane bending vibration) of olefin at 965 cm⁻¹±10 cm⁻¹ and 990 cm⁻¹±10 cm⁻¹ in an infrared absorption spectrum.

An amount of the non-crystalline polyester resin B is not particularly limited and may be appropriately selected depending on the intended purpose, but it is preferably 50 parts by mass to 90 parts by mass, more preferably 60 parts by mass to 80 parts by mass, relative to 100 parts by mass of the toner. When the amount thereof is less than 50 parts by mass, dispersibility of the pigment and the release agent in the toner may be deteriorated, and fogging and degradation of an image may be caused. Meanwhile, when the amount thereof is more than 90 parts by mass, the amount of the crystalline polyester resin C and the non-crystalline polyester resin A are low, which may deteriorate low temperature fixing ability. When the amount thereof is within more preferable range than the aforementioned range, it is advantageous because a resultant toner is excellent in terms of both high image quality and low temperature fixing ability.

### <Crystalline Polyester Resin C>

Crystalline polyester resin C exhibits heat melting characteristics where it causes drastic viscosity lowering at temperature around fixing onset temperature, since the crystalline polyester resin C has high crystallinity. By using the crystalline polyester resin C having these characteristics together with the non-crystalline polyester resin B, the heat resistant storage stability of the toner is excellent up to the melt onset temperature owing to crystallinity, and the toner drastically decreases its viscosity (sharp melt properties) at the melt onset temperature because of melting of the crystalline polyester resin C. Along with the drastic decrease in viscosity, the crystalline polyester resin C is melt together with the non-crystalline polyester resin B, to drastically decrease their viscosity to thereby be fixed. Accordingly, a toner having excellent heat resistant storage stability and low temperature fixing ability can be obtained. Moreover, the toner has excellent results in terms of a releasing width (a difference between the minimum fixing temperature and hot offset occurring temperature).

The crystalline polyester resin C is obtained from a polyhydric alcohol and a multivalent carboxylic acid or a derivative thereof such as a multivalent carboxylic acid anhydride and a multivalent carboxylic acid ester.

Note that, in the present invention, the crystalline polyester resin C is one obtained from a polyhydric alcohol and a multivalent carboxylic acid or a derivative thereof such as a multivalent carboxylic acid anhydride and a multivalent carboxylic acid ester, as described above, and a resin obtained by modifying a polyester resin, for example, the aforementioned prepolymer and a resin obtained through cross-linking and/or chain elongation reaction of the prepolymer do not belong to the crystalline polyester resin C.

### —Polyhydric Alcohol—

The polyhydric alcohol is not particularly limited and may be appropriately selected depending on the intended purpose. Examples thereof include diol, and trihydric or more alcohol.

Examples of the diol include saturated aliphatic diol. Examples of the saturated aliphatic diol include straight chain saturated aliphatic diol, and branched-chain saturated aliphatic diol. Among them, straight chain saturated aliphatic diol is preferable, and a straight chain saturated aliphatic diol having 2 to 12 carbons is more preferable. When the saturated aliphatic diol has a branched-chain structure, crystallinity of the crystalline polyester resin C may be low, which may lower the melting point. When the number of carbon atoms in the saturated aliphatic diol is greater than 12, it may be difficult to yield a material in practice. The number of carbon atoms therein is preferably 12 or less.

Examples of the saturated aliphatic diol include ethylene glycol, 1,3-propanediol, 1,4-butanediol, 1,5-pentanediol, 1,6-hexanediol, 1,7-heptanediol, 1,8-octanediol, 1,9-nonanediol, 1,10-decanediol, 1,11-undecanediol, 1,12-dodecanediol, 1,13-tridecanediol, 1,14-tetradecanediol, 1,18-octadecanediol, and 1,14-eicosanedecanediol. Among them, ethylene glycol, 1,4-butanediol, 1,6-hexanediol, 1,8-octanediol, 1,10-decanediol, and 1,12-dodecanediol are preferable, as they give high crystallinity to a resultant crystalline polyester resin C, and give excellent sharp melt properties.

Examples of the trihydric or more alcohol include glycerin, trimethylol ethane, trimethylolpropane, and pentaerythritol.

These may be used alone or in combination thereof.

### —Multivalent Carboxylic Acid—

The multivalent carboxylic acid is not particularly limited and may be appropriately selected depending on the intended purpose. Examples thereof include divalent carboxylic acid, and trivalent or more carboxylic acid.

Examples of the divalent carboxylic acid include: saturated aliphatic dicarboxylic acid, such as oxalic acid, succinic acid, glutaric acid, adipic acid, suberic acid, azelaic acid, sebacic acid, 1,9-nonanedicarboxylic acid, 1,10-decanedicarboxylic acid, 1,12-dodecanedicarboxylic acid, 1,14-tetradecanedicarboxylic acid, and 1,18-octadecanedicarboxylic acid; aromatic dicarboxylic acid of dibasic acid, such as phthalic acid, isophthalic acid, terephthalic acid, naphthalene-2,6-dicarboxylic acid, malonic acid, and mesaconic acid; and anhydrides of the foregoing compounds, and lower (C1-C3) alkyl ester of the foregoing compounds.

Examples of the trivalent or more carboxylic acid include 1,2,4-benzenetricarboxylic acid, 1,2,5-benzenetricarboxylic acid, 1,2,4-naphthalene tricarboxylic acid, anhydrides thereof, and lower (C1-C3) alkyl esters thereof.

Moreover, the multivalent carboxylic acid may contain, other than the saturated aliphatic dicarboxylic acid or aromatic dicarboxylic acid, dicarboxylic acid containing a sulfonic acid group. Further, the multivalent carboxylic acid may contain, other than the saturated aliphatic dicarboxylic acid or aromatic dicarboxylic acid, dicarboxylic acid having a double bond.

These may be used alone or in combination thereof.

The crystalline polyester resin C is preferably composed of a straight chain saturated aliphatic dicarboxylic acid having 4 to 12 carbon atoms and a straight chain saturated aliphatic diol having 2 to 12 carbon atoms. Specifically, the crystalline polyester resin C preferably contains a constituent unit derived from a saturated aliphatic dicarboxylic acid having 4 to 12 carbon atoms, and a constituent unit derived from a saturated aliphatic diol having 2 to 12 carbon atoms. As a result of this, the resultant toner may be excellent in high crystallinity and sharp melt properties, which may lead to excellent low temperature fixing ability of the toner.

A melting point of the crystalline polyester resin C is not particularly limited and may be appropriately selected depending on the intended purpose, but it is preferably 60° C. to 80° C. When the melting point thereof is lower than 60° C., the crystalline polyester resin C tends to be melted at low temperature, which may impair heat resistant storage stability of the toner. When the melting point thereof is higher than 80° C., melting of the crystalline polyester resin C with heat applied during fixing may be insufficient, which may impair low temperature fixing ability of the toner.

A molecular weight of the crystalline polyester resin C is not particularly limited and may be appropriately selected depending on the intended purpose. Since those having a sharp molecular weight distribution and low molecular weight have excellent low temperature fixing ability, and heat resistant storage stability of a resultant toner lowers as an amount of a low molecular weight component, an o-dichlorobenzene soluble component of the crystalline polyester resin C preferably has the weight average molecular weight (Mw) of 3,000 to 30,000, number average molecular weight (Mn) of 1,000 to 10,000, and Mw/Mn of 1.0 to 10, as measured by GPC.

Further, it is more preferred that the weight average molecular weight (Mw) thereof be 5,000 to 15,000, the number average molecular weight (Mn) thereof be 2,000 to 10,000, and the Mw/Mn is 1.0 to 5.0.

An acid value of the crystalline polyester resin C is not particularly limited and may be appropriately selected depending on the intended purpose, but it is preferably 5 mgKOH/g or higher, more preferably 10 mgKOH/g or higher for achieving the desired low temperature fixing ability in view of affinity between paper and the resin. Meanwhile, the acid value thereof is preferably 45 mgKOH/g or lower for the purpose of improving hot offset resistance.

A hydroxyl value of the crystalline polyester resin C is not particularly limited and may be appropriately selected depending on the intended purpose, but it is preferably 0 mgKOH/g to 50 mgKOH/g, more preferably 5 mgKOH/g to 50 mgKOH/g, for achieving the desired low temperature fixing ability and excellent charging properties.

A molecular structure of the crystalline polyester resin C can be confirmed by solution-state or solid-state NMR, X-ray diffraction, GC/MS, LC/MS, or IR spectroscopy. Simple methods thereof include a method for detecting, as the crystalline polyester resin C, one that has absorption based on δCH (out-of-plane bending vibration) of olefin at 965 cm⁻¹±10 cm⁻¹ and 990 cm⁻¹±10 cm⁻¹ in an infrared absorption spectrum.

An amount of the crystalline polyester resin C is not particularly limited and may be appropriately selected depending on the intended purpose, but it is preferably 3 parts by mass to 20 parts by mass, more preferably 5 parts by mass to 15 parts by mass, relative to 100 parts by mass of the toner. When the amount thereof is less than 3 parts by mass, the crystalline polyester resin C does not give sufficient sharp melt properties, which may lead to insufficient low temperature fixing ability of a resultant toner. When the amount thereof is greater than 20 parts by mass, a resultant toner may have low heat resistant storage stability, and tends to cause fogging of an image. When the amount thereof is within the aforementioned more preferable range, it is advantageous because a resultant toner is excellent in terms of both high image quality and low temperature fixing ability.

### <Other Components>

Besides the aforementioned components, a release agent, a colorant, an external additive, a flow improving agent, a cleaning improving agent, and a magnetic material can be included in a toner of the present invention.

### —Release Agent—

The release agent is appropriately selected from those known in the art without any limitation.

As a release agent containing waxes, natural waxes is included. Examples thereof include; vegetable waxes such as carnauba wax, cotton wax, Japan wax and rice wax; animal waxes such as bees wax and lanolin; mineral waxes such as ozokerite and ceresin; and petroleum waxes such as paraffin, microcrystalline wax and petrolatum.

Besides these natural waxes, examples of the release agent include synthetic hydrocarbon waxes such as fischer-tropsch wax, polyethylene and polypropylene; and synthetic waxes such as ester, ketone, and ether.

Further, other examples of the release agent include fatty acid amides such as 12-hydroxystearic acid amide, stearic acid amide, phthalic anhydride imide and chlorinated hydrocarbons; low-molecular-weight crystalline polymers such as acrylic homopolymers (e.g., poly-n-stearyl methacrylate and poly-n-lauryl methacrylate) and acrylic copolymers (e.g., n-stearyl acrylate-ethyl methacrylate copolymers); and crystalline polymers having a long alkyl group at a side chain.

Among them, synthetic hydrocarbon waxes such as paraffin wax, microcrystalline wax, fischer-tropsch wax, polyethylene wax and polypropylene wax are preferable.

A melting point of the release agent is not particularly limited and may be appropriately selected depending on the intended purpose, but it is preferably 60° C. to 80° C. When the melting point thereof is lower than 60° C., the release agent tends to melt at low temperature, which may impair heat resistant storage stability. When the melting point thereof is higher than 80° C., the release agent is not sufficiently melted to thereby cause fixing offset even in the case where the resin is melted and is in the fixing temperature range, which may cause defects in an image.

An amount of the release agent is appropriately selected depending on the intended purpose without any limitation, but it is preferably 2 parts by mass to 10 parts by mass, more preferably 3 parts by mass to 8 parts by mass, relative to 100 parts by mass of the toner. When the amount thereof is less than 2 parts by mass, a resultant toner may have insufficient hot offset resistance, and low temperature fixing ability during fixing. When the amount thereof is greater than 10 parts by mass, a resultant toner may have insufficient heat resistant storage stability, and tends to cause fogging in an image. When the amount thereof is within the aforementioned more preferable range, it is advantageous because image quality and fixing stability can be improved.

### —Colorant—

The colorant is appropriately selected depending on the intended purpose without any limitation, and examples thereof include carbon black, a nigrosin dye, iron black, naphthol yellow S, Hansa yellow (10G, 5G and G), cadmium yellow, yellow iron oxide, yellow ocher, yellow lead, titanium yellow, polyazo yellow, oil yellow, Hansa yellow (GR, A, RN and R), pigment yellow L, benzidine yellow (G and GR), permanent yellow (NCG), vulcan fast yellow (5G, R), tartrazine lake, quinoline yellow lake, anthrasan yellow BGL, isoindolinon yellow, colcothar, red lead, lead vermilion, cadmium red, cadmium mercury red, antimony vermilion, permanent red 4R, parared, fiser red, parachloroorthonitro anilin red, lithol fast scarlet G, brilliant fast scarlet, brilliant carmine BS, permanent red (F2R, F4R, FRL, FRLL and F4RH), fast scarlet VD, vulcan fast rubin B, brilliant scarlet G, lithol rubin GX, permanent red F5R, brilliant carmine 6B, pigment scarlet 3B, Bordeaux 5B, toluidine Maroon, permanent Bordeaux F2K, Helio Bordeaux BL, Bordeaux 10B, BON maroon light, BON maroon medium, eosin lake, rhodamine lake B, rhodamine lake Y, alizarin lake, thioindigo red B, thioindigo maroon, oil red, quinacridone red, pyrazolone red, polyazo red, chrome vermilion, benzidine orange, perinone orange, oil orange, cobalt blue, cerulean blue, alkali blue lake, peacock blue lake, Victoria blue lake, metal-free phthalocyanine blue, phthalocyanine blue, fast sky blue, indanthrene blue (RS and BC), indigo, ultramarine, iron blue, anthraquinone blue, fast violet B, methyl violet lake, cobalt purple, manganese violet, dioxane violet, anthraquinone violet, chrome green, zinc green, chromium oxide, viridian, emerald green, pigment green B, naphthol green B, green gold, acid green lake, malachite green lake, phthalocyanine green, anthraquinone green, titanium oxide, zinc flower, and lithopone.

An amount of the colorant is not particularly limited and may be appropriately selected depending on the intended purpose, but it is preferably 1 part by mass to 15 parts by mass, more preferably 3 parts by mass to 10 parts by mass, relative to 100 parts by mass of the toner.

The colorant may be used as a master batch in which the colorant forms a composite with a resin. Examples of the binder resin kneaded in the production of, or together with the master batch include, other than the aforementioned non-crystalline polyester resin B, polymer of styrene or substitution thereof (e.g., polystyrene, poly-p-chlorostyrene, and polyvinyl); styrene copolymer (e.g., styrene-p-chlorostyrene copolymer, styrene-propylene copolymer, styrene-vinyl toluene copolymer, styrene-vinyl naphthalene copolymer, styrene-methyl acrylate copolymer, styrene-ethyl acrylate copolymer, styrene-butyl acrylate copolymer, styrene-octyl acrylate copolymer, styrene-methyl methacrylate copolymer, styrene-ethyl methacrylate copolymer, styrene-butyl methacrylate copolymer, styrene-methyl α-chloromethacrylate copolymer, styrene-acrylonitrile copolymer, styrene-methyl vinyl ketone copolymer, styrene-butadiene copolymer, styrene-isoprene copolymer, styrene-acrylonitrile-indene copolymer, styrene-maleic acid copolymer, and styrene-maleic acid ester copolymer); and others including polymethyl methacrylate, polybutyl methacrylate, polyvinyl chloride, polyvinyl acetate, polyethylene, polypropylene, polyester, epoxy resin, epoxy polyol resin, polyurethane, polyamide, polyvinyl butyral, polyacrylic acid resin, rosin, modified rosin, a terpene resin, an aliphatic or alicyclic hydrocarbon resin, an aromatic petroleum resin, chlorinated paraffin, and paraffin wax. These may be used alone or in combination thereof.

The master batch can be prepared by mixing and kneading the colorant with the resin for the master batch. In the mixing and kneading, an organic solvent may be used for improving the interactions between the colorant and the resin. Moreover, the master batch can be prepared by a flashing method in which an aqueous paste containing a colorant is mixed and kneaded with a resin and an organic solvent, and then the colorant is transferred to the resin to remove the water and the organic solvent. This method is preferably used because a wet cake of the colorant is used as it is, and it is not necessary to dry the wet cake of the colorant to prepare a colorant. In the mixing and kneading of the colorant and the resin, a high-shearing disperser (e.g., a three-roll mill) is preferably used.

### —External Additive—

As for the external additive, other than oxide particles, a combination of inorganic particles and hydrophobic-treated inorganic particles can be used. The average primary particle diameter of the hydrophobic-treated particles is preferably 1 nm to 100 nm. More preferred are 5 nm to 70 nm of the inorganic particles.

Moreover, it is preferred that the external additive contain at least one type of hydrophobic-treated inorganic particles having the average primary particle diameter of 20 nm or smaller, and at least one type of inorganic particles having the average primary particle diameter of 30 nm or greater. Moreover, the external additive preferably has the BET specific surface area of 20 m²/g to 500 m²/g.

The external additive is not particularly limited and may be appropriately selected depending on the intended purpose. Examples thereof include silica particles, hydrophobic silica, fatty acid metal salts (e.g., zinc stearate, and aluminum stearate), metal oxide (e.g., titania, alumina, tin oxide, and antimony oxide), and a fluoropolymer.

Examples of the suitable additive include hydrophobic silica, titania, titanium oxide, and alumina particles. Examples of the silica particles include R972, R974, RX200, RY200, R202, R805, and R812 (all products of Nippon Aerosil Co., Ltd.). Examples of the titania particles include P-25 (product of Nippon Aerosil Co., Ltd.); STT-30, STT-65C-S (both product of Titan Kogyo, Ltd.); TAF-140 (product of Fuji Titanium Industry Co., Ltd.); and MT-150W, MT-500B, MT-600B, MT-150 A (all products of TAYCA CORPORATION).

Examples of the hydrophobic treated titanium oxide particles include: T-805 (product of Nippon Aerosil Co., Ltd.); STT-30A, STT-65S-S (both products of Titan Kogyo, Ltd.); TAF-500T, TAF-1500T (both products of Fuji Titanium Industry Co., Ltd.); MT-100S, MT-100T (both product of TAYCA CORPORATION); and IT-S (product of ISHIHARA SANGYO KAISHA, LTD.).

The hydrophobic-treated oxide particles, hydrophobic-treated silica particles, hydrophobic-treated titania particles, and hydrophobic-treated alumina particles are obtained, for example, by treating hydrophilic particles with a silane coupling agent, such as methyltrimethoxy silane, methyltriethoxy silane, and octyltrimethoxy silane. Moreover, silicone oil-treated oxide particles, or silicone oil-treated inorganic particles, which have been treated by adding silicone oil optionally with heat, are also suitably used as the external additive.

Examples of the silicone oil include dimethyl silicone oil, methylphenyl silicone oil, chlorophenyl silicone oil, methyl hydrogen silicone oil, alkyl-modified silicone oil, fluorine-modified silicone oil, polyether-modified silicone oil, alcohol-modified silicone oil, amino-modified silicone oil, epoxy-modified silicone oil, epoxy-polyether-modified silicone oil, phenol-modified silicone oil, carboxyl-modified silicone oil, mercapto-modified silicone oil, methacryl-modified silicone oil, and α-methylstyrene-modified silicone oil. Examples of the inorganic particles include silica, alumina, titanium oxide, barium titanate, magnesium titanate, calcium titanate, strontium titanate, iron oxide, copper oxide, zinc oxide, tin oxide, quartz sand, clay, mica, wollastonite, diatomaceous earth, chromic oxide, cerium oxide, red iron oxide, antimony trioxide, magnesium oxide, zirconium oxide, barium sulfate, barium carbonate, calcium carbonate, silicon carbide, and silicon nitride. Among them, silica and titanium dioxide are preferable.

The amount of the external additive is not particularly limited and may be appropriately selected depending on the intended purpose. The amount thereof is preferably 0.1 parts by mass to 5 parts by mass, more preferably 0.3 parts by mass to 3 parts by mass, relative to 100 parts by mass of the toner.

The average particle diameter of primary particles of the inorganic particles is not particularly limited and may be appropriately selected depending on the intended purpose, but it is preferably 100 nm or smaller, more preferably 3 nm to 70 nm. When it is less than the aforementioned range, the inorganic particles are embedded in the toner particles, and therefore the function of the inorganic particles may not be effectively exhibited. When the average particle diameter thereof is greater than the aforementioned range, the inorganic particles may unevenly damage a surface of a photoconductor, which not preferable.

### —Flowability Improving Agent—

The flowability improving agent is not particularly limited and may be appropriately selected depending on the intended purpose so long as it is capable of performing surface treatment of the toner to increase hydrophobicity, and preventing degradations of flow properties and charging properties of the toner even in a high humidity environment. Examples thereof include a silane-coupling agent, a sililation agent, a silane-coupling agent containing a fluoroalkyl group, an organic titanate-based coupling agent, an aluminum-based coupling agent, silicone oil, and modified silicone oil. It is particularly preferred that the silica or the titanium oxide are used as hydrophobic silica or hydrophobic titanium oxide subjected to surface treatment with the aforementioned flow improving agent.

### —Cleanability Improving Agent—

The cleanability improving agent is not particularly limited and may be appropriately selected depending on the intended purpose so long as it can be added to the toner for the purpose of removing the developer remained on a photoconductor or primary transfer member after transferring. Examples thereof include; fatty acid metal salt such as zinc stearate, calcium stearate, and stearic acid; and polymer particles produced by soap-free emulsion polymerization, such as polymethyl methacrylate particles, and polystyrene particles. The polymer particles are preferably those having a relatively narrow particle size distribution, and the polymer particles having the volume average particle diameter of 0.01 μm to 1 μm are preferably used.

### —Magnetic Material—

The magnetic material is not particularly limited and may be appropriately selected depending on the intended purpose. Examples thereof include iron powder, magnetite, and ferrite. Among them, a white magnetic material is preferable in terms of a color tone.

<Glass Transition Temperature (Tg1st)>

The glass transition temperature (Tg1st) of the toner is preferably 10° C. to 60° C., more preferably 20° C. to 50° C., where the glass transition temperature (Tg1st) is measured in first heating of differential scanning calorimetry (DSC).

If the Tg of a conventional toner is lowered to be about 50° C. or lower, the conventional toner tends to cause aggregation of toner particles influenced by temperature variations during transportation or storage of the toner in summer or in a tropical region. As a result, the toner is solidified in a toner bottle, or within a developing unit. Moreover, supply failures due to clogging of the toner in the toner bottle, and formation of defected images due to toner adherence are likely to occur.

The toner preferably has a lower Tg than conventional toners. When the non-crystalline polyester resin A, which is a low Tg component in a toner, is non-linear, the toner can maintain its heat resistant storage stability. In particular, in cases where the non-crystalline polyester resin A has a urethane bond or a urea bond responsible for high aggregation force, the effect of retaining heat resistant storage stability is more significant.

When the Tg1st is lower than 20° C., the toner may have poor heat resistant storage stability, may cause blocking within a developing unit, and may cause filming on a photoconductor. When it is higher than 50° C., the toner may have poor low temperature fixing ability.

<Glass Transition Temperature (Tg2nd)>

A glass transition temperature (Tg2nd), where the glass transition temperature (Tg2nd) is measured in the second heating in differential scanning calorimetry (DSC) of the toner, is preferably −5° C. to 45° C., more preferably −5° C. to 30° C.

A difference (Tg1st−Tg2nd) between the glass transition temperature (Tg1st) of the toner as measured in the first heating in differential scanning calorimetry (DSC) and the glass transition temperature (Tg2nd) of the toner as measured in the second heating in DSC is not particularly limited and may be appropriately selected depending on the intended purpose, but it is preferably 10° C. or greater. The upper limit of the difference is not particularly limited and may be appropriately selected depending on the intended purpose, but it is preferably 50° C. or less.

When the difference is 10° C. or more, the resultant toner is advantageous because it is excellent in low temperature fixing ability. The difference of 10° C. or more means that the crystalline polyester resin C is non-compatible state with the non-crystalline polyester resin A and the non-crystalline polyester resin B before heating (before the first heating), and then they become a compatible state after heating (after the first heating). Note that, the compatible state after heating may not be a complete compatible state.

A melting point of the toner is not particularly limited and may be appropriately selected depending on the intended purpose, but it is preferably 60° C. to 80° C.

The volume average particle diameter of the toner is not particularly limited and may be appropriately selected depending on the intended purpose, but it is preferably 3 μm to 7 μm. Moreover, a ratio of the volume average particle diameter to the number average particle diameter is preferably 1.2 or less. Further, the toner preferably contains toner particles having the volume average particle diameter of 2 μM or smaller, in an amount of 1% by number to 10% by number.

### <Calculation Methods and Analysis Methods of Various Properties of Toner and Constituent Component of Toner>

The Tg, acid value, hydroxyl value, molecular weight, and melting point of the polyester resin, the polyester resin (e.g. the non-crystalline polyester resin A, the non-crystalline polyester resin B, the crystalline polyester resin C), and the release agent may be each measured. Alternatively, each component may be separated from an actual toner by gel permeation chromatography (GPC) or the like, and separated each component may be subjected to the analysis methods described later, to thereby calculate Tg, molecular weight, melting point, and mass ratio of a constituent component.

Separation of each component by GPC can be performed, for example, by the following method.

In GPC using THF (tetrahydrofuran) as a mobile phase, an eluate is subjected to fractionation by a fraction collector, a fraction corresponding to a part of a desired molecular weight is collected from a total area of an elution curve. The collected eluates are concentrated and dried by an evaporator or the like, and a resultant solid content is dissolved in a deuterated solvent, such as deuterated chloroform, and deuterated THF, followed by measurement of ¹H-NMR. From an integral ratio of each element, a ratio of a constituent monomer of the resin in the elution composition is calculated.

As another method, after concentrating the eluate, hydrolysis is performed with sodium hydroxide or the like, and a ratio of a constituent monomer is calculated by subjecting the decomposed product to a qualitative or quantitative analysis by high performance liquid chromatography (HPLC).

Note that, in the case where the method for producing a toner produces toner base particles by generating the non-crystalline polyester resin A through a chain-elongation reaction and/or cross-linking reaction of the non-linear chain reactive precursor and the curing agent, the polyester resin may be separated from an actual toner by GPC or the like, to thereby determine Tg thereof. Alternatively, the non-crystalline polyester resin A is separately generated through a chain-elongation reaction and/or cross-linking reaction of the non-linear chain reactive precursor and the curing agent, and Tg may be measured on the synthesized non-crystalline polyester resin A.

### <Separation Unit for Toner Constituent Components, and Measurements of Molecular Weight and Molecular Weight Distribution>

A measuring device, HLC-8020GPC (product of TOSOH CORPORATION) is used. A column of the measuring device is used by connecting three columns (TSKgel Super HZM-H). The measurements are conducted as follows.

The column is stabilized in a heat chamber having a temperature of 40° C. THF as a solvent is flowed at a flow rate of 0.35 mL/min, followed by charging 10 μL of the toner or the resin containing THF sample solution prepared to have a sample concentration of 0.05% by mass to 0.6% by mass with the columns having a temperature of 40° C. In measuring weight average molecular weight (Mw) and molecular weight distribution, the molecular weight distribution having the sample are calculated based on the relationship between the logarithmic value and the count number of a calibration curve given by using several monodisperse polystyrene-standard samples. As the standard polystyrene samples used for giving the calibration curve, Showdex STANDARD series having a Mp of 6540000, 3570000, 651000, 251000, 110000, 45000, 19300, 6700, 2800, 580 (these products are of SHOWA DENKO K.K.) and toluene are used. The detector used is a refractive index (RI) detector.

A ratio of component having a molecular weight of 600 or less is determined based on a point of intersection between molecular weight 600 and a curb in an integral molecular weight distribution curve.

Meanwhile, a fraction collector is disposed at an eluate outlet of GPC, to fraction the eluate per a certain count. The eluate is obtained per 5% in terms of the area ratio from the elution onset on the elution curve (rise of the curve).

Next, each eluted fraction, as a sample, in an amount of 30 mg is dissolved in 1 mL of deuterated chloroform, and to this solution, 0.05% by volume of tetramethyl silane (TMS) is added as a standard material.

A glass tube for NMR having a diameter of 5 mm is charged with the solution, from which a spectrum is obtained by a nuclear magnetic resonance apparatus (JNM-AL 400, product of JEOL Ltd.) by performing multiplication 128 times at temperature of 23° C. to 25° C.

The monomer compositions and the compositional ratios of the non-crystalline polyester resin A, the non-crystalline polyester resin B, and the crystalline polyester resin C in the toner are determined from peak integral ratios of the obtained spectrum.

For example, an assignment of a peak is performed in the following manner, and a constituent monomer component ratio is determined from each integral ratio.

The assignment of a peak is as follows:

Around 8.25 ppm: derived from a benzene ring of trimellitic acid (for one hydrogen atom)

Around the region of 8.07 ppm to 8.10 ppm: derived from a benzene ring of terephthalic acid (for four hydrogen atoms)

Around the region of 7.1 ppm to 7.25 ppm: derived from a benzene ring of bisphenol A (for four hydrogen atoms)

Around 6.8 ppm: derived from a benzene ring of bisphenol A (for four hydrogen atoms), and derived from a double bond of fumaric acid (for two hydrogen atoms)

Around the region of 5.2 ppm to 5.4 ppm: derived from methine of bisphenol A propylene oxide adduct (for one hydrogen atom)

Around the region of 3.7 ppm to 4.7 ppm: derived from methylene of a bisphenol A propylene oxide adduct (for two hydrogen atoms), and derived from methylene of a bisphenol A ethylene oxide (for four hydrogen atoms)

Around 1.6 ppm: derived from a methyl group of bisphenol A and an aliphatic alcohol (for six hydrogen atoms).

From these results, for example, the extract collected in a fraction containing the non-crystalline polyester resin A in an amount of 90% or more can be treated as the non-crystalline polyester resin A. Similarly, the extract collected in a fraction containing the non-crystalline polyester resins B and C in an amount of 90% or more can be treated as the non-crystalline polyester resins B and C, respectively.

### <Measurement Method of Fluorine Content Ratio>

### <<Combustion Ion Chromatography (CIC)>>

A mass ratio of a fluorine atom in the resultant toner [fluorine content ratio (CIC) (ppm)] can be determined by combustion ion chromatography.

In the present invention, the [fluorine content ratio (CIC) (ppm)] is measured with the following devices and conditions.

(i) Sample-burning device: AQF-100, product of Mitsubishi Chemical Analytech, Co., Ltd.
(ii) Conditions of the sample-burning device

### Combustion Temperature:

inlet temp 900° C.

outlet temp 1,000° C.

Gas: Ar/O₂: 200 mL/min, O₂: 400 mL/min, Ar: 150 mL/min
Absorber: hydrogen peroxide 90 ppm 3 mL
Sample loop: 100 μL
(iii) Ion chromatograph: ICS-1500, product of DIONEX
(iv) Conditions of ion chromatograph

Negative ion-analysis column: IONPAC AS12A

Guard column: IONPAC AG12A

Solution: 2.7 mM Na₂CO₃/0.3 mM NAHCO₃

Column temperature: 35° C.

### <<X-Ray Photoelectron Spectroscopic Analysis (XPS)>>

The fluorine content ratio (XPS) (%) can be determined by X-ray photoelectron spectroscopic analysis (XPS).

A fluorine content ratio (%) of the toner surface can be determined by the X-ray photoelectron spectroscopic analysis (XPS). The fluorine content ratio (%) means atomic %.

In the present invention, the fluorine content ratio (XPS) (%) is measured by the following devices and conditions.

A sample is charged into an aluminum tray, and then the tray is attached to a specimen holder by using a carbon sheet for the measurement of the fluorine content ratio (XPS) (%). A relative sensitivity factor of Kratos is employed in order to calculate a concentration of the surface atom.

Measuring device: AXIS-ULTRA, product of Kratos

Measuring light source: Al (monochromator)

Measuring output: 105 W (15 kV, 7 mA)

Analysical area: 900 μm×600 μm

Measuring mode: Hybrid mode

Pass energy: (wide scan) 160 eV, (narrow scan) 40 eV

Energy step size: (wide scan) 1.0 eV, (narrow scan) 0.2 eV

Relative sensitivity factor: Used relative sensitivity factor of Kratos

### <THF Insoluble Matter>

Tetrahydrofuran (THF) insoluble matter contains the non-crystalline polyester resin A as a main component. The THF insoluble matter and the THF soluble matter of the toner can be obtained according to the following procedure.

First, 1 part of the toner is added to 40 parts of THF, and the resultant mixture is refluxed for 6 hours. Then, an insoluble matter in the resultant mixture is allowed to precipitate by a centrifugal separator, and the supernatant is separated from the insoluble matter.

Next, the insoluble matter is dried at 40° C. for 20 hours, to thereby obtain THF insoluble matter. Moreover, the solvent is eliminated from the supernatant, followed by drying at 40° C. for 20 hours, to thereby obtain THF soluble matter.

A ratio of the THF insoluble matter in the toner is not particularly limited and may be appropriately selected depending on the intended purpose, but it is preferably 15% by mass to 35% by mass, more preferably 20% by mass to 30% by mass. When the ratio thereof is less than 15%, the resultant toner may deteriorate low temperature fixing ability. When the ratio thereof is more than 35%, the resultant toner may deteriorate heat resistant storage stability.

### <[Tg2nd (THF Insoluble Matter)]>

The glass transition temperature [Tg2nd (THF insoluble matter)], which is measured in second heating of differential scanning calorimetry (DSC), is not particularly limited and may be appropriately selected depending on the intended purpose. It is preferably −45° C. to 40° C., more preferably −40° C. to 30° C., still more preferably 0° C. to 20° C. When the [Tg2nd (THF insoluble matter] is less then −45° C., heat resistant storage stability of the toner may be deteriorated. When the [Tg2nd (THF insoluble matter)] is more than 40° C., low temperature fixing ability of the toner may be deteriorated.

The [Tg2nd (THF insoluble matter)] is corresponded to the Tg second of a non-linear non-crystalline polyester resin A, and is advantageous for low temperature fixing ability.

The [Tg2nd (THF insoluble matter)] can be adjusted by changing, for example, the resin composition (i.e. by selecting bi- or more functional polyol and/or bi- or more functional acid component).

Specifically, in order to lower the Tg, a polyol having an alkyl group in a side chain as a constituent may be used. In order to increase the Tg, a distance of the ester bond in the resin may be shorten.

### <<Measurement Methods of Melting Point and Glass Transition Temperature (Tg)>>

In the present invention, a melting point and glass transition temperature can be measured, for example, by DSC system (differential scanning calorimeter, Q-200: product of TA Instruments Japan Inc.).

Specifically, a melting point and glass transition temperature (Tg) of a sample are measured in the following manners.

Specifically, first, an aluminum sample container charged with about 5.0 mg of a sample is placed on a holder unit, and the holder unit is then set in an electric furnace. Next, the sample is heated (first heating) from −80° C. to 150° C. at the heating rate of 10° C./min in a nitrogen atmosphere. Then, the sample is cooled from 150° C. to −80° C. at the cooling rate of 10° C./min, followed by again heating (second heating) to 150° C. at the heating rate of 10° C./min. DSC curves are respectively measured for the first heating and the second heating by a differential scanning calorimeter (Q-200: product of TA Instruments Japan Inc.).

The DSC curve for the first heating is selected from the obtained DSC curve by an analysis program stored in the Q-200 system, to thereby determine glass transition temperature of the sample with the first heating. Similarly, the DSC curve for the second heating is selected, and the glass transition temperature of the sample with the second heating can be determined.

Moreover, the DSC curve for the first heating is selected from the obtained DSC curve by the analysis program stored in the Q-200 system, and an endothermic peak top temperature of the sample for the first heating is determined as a melting point of the sample. Similarly, the DSC curve for the second heating is selected, and the endothermic peak top temperature of the sample for the second heating can be determined as a melting point of the sample with the second heating.

In the present description, when a toner is used as a target sample, the glass transition temperature of the toner in first heating is defined as Tg1st, and the glass transition temperature of the toner in second heating is defined as Tg2nd.

Also in the present invention, regarding the glass transition temperature and the melting point of the non-crystalline polyester resin A, the non-crystalline polyester resin B, the crystalline polyester resin C, and the other constituent components such as the release agent, the endothermic peak top temperature and the Tg in the second heating are defined as the melting point and the Tg of each of the target samples, respectively, unless otherwise specified.

### <Measurement Method for Particle Size Distribution>

The volume average particle diameter (D4), the number average particle diameter (Dn), and the ratio therebetween (D4/Dn) of the toner can be measured using, for example, Coulter Counter TA-II or Coulter Multisizer II (these products are of Coulter, Inc.). In the present invention, Coulter Multisizer II was used. The measurement method is as follows.

First, a surfactant (0.1 mL to 5 mL), preferably a polyoxyethylene alkyl ether (nonionic surfactant), is added as a dispersing agent to an aqueous electrolyte solution (100 mL to 150 mL). Here, the aqueous electrolyte solution is an 1% by mass aqueous NaCl solution prepared using 1st grade sodium chloride, and ISOTON-II (product of Coulter, Inc.) can be used as the aqueous electrolyte solution. Next, a measurement sample in an amount of 2 mg to 20 mg is added therein. The resultant aqueous electrolyte solution in which the sample has been suspended is dispersed with an ultrasonic wave disperser for about 1 min to about 3 min. The thus-obtained dispersion liquid is analyzed with the above-described apparatus using an aperture of 100 μm to measure the number or volume of the toner particles (or toner). Then, the volume particle size distribution and the number particle size distribution are calculated from the obtained values. From these distributions, the volume average particle diameter (D4) and the number average particle diameter (Dn) of the toner can be obtained.

In this measurement, 13 channels are used: 2.00 μm (inclusive) to 2.52 μm (exclusive); 2.52 μm (inclusive) to 3.17 μm (exclusive); 3.17 μm (inclusive) to 4.00 μm (exclusive); 4.00 μm (inclusive) to 5.04 μm (exclusive); 5.04 μm (inclusive) to 6.35 μm (exclusive); 6.35 μm (inclusive) to 8.00 μm (exclusive); 8.00 μM (inclusive) to 10.08 μm (exclusive); 10.08 μm (inclusive) to 12.70 μm (exclusive); 12.70 μm (inclusive) to 16.00 μm (exclusive); 16.00 μm (inclusive) to 20.20 μm (exclusive); 20.20 μm (inclusive) to 25.40 μm (exclusive); 25.40 μm (inclusive) to 32.00 μm (exclusive); and 32.00 μm (inclusive) to 40.30 μm (exclusive); i.e., particles having a particle diameter of 2.00 μm (inclusive) to 40.30 μm (exclusive) are subjected to the measurement.

### <Measurement of Molecular Weight>

The molecular weight of each of the constituent components of the toner can be measured by the following method, for example.

Gel permeation chromatography (GPC) measuring apparatus:

GPC-8220 GPC (product of TOSOH CORPORATION)

Column: TSKgel Super HZM-H 15 cm, 3 columns connected (product of TOSOH CORPORATION)

Temperature: 40° C.

Solvent: THF

Flow rate: 0.35 mL/min

Sample: 0.15% by mass sample

Pretreatment of sample: The toner is dissolved in tetrahydrofuran (THF) (containing a stabilizer, product of Wako Pure Chemical Industries, Ltd.) in a concentration of 0.15% by mass, and the solution is filtrated with a 0.2-μm filter. The resultant filtrate is used as a sample. This THF sample solution (100 μL) is applied for measurement.

In the measurement of the molecular weight of the sample, the molecular weight distribution of the sample is determined based on the relationship between the logarithmic value and the count number of a calibration curve given by using several monodisperse polystyrene-standard samples. The standard polystyrene samples used for giving the calibration curve are Showdex STANDARD Std. Nos. S-7300, S-210, S-390, S-875, S-1980, S-10.9, S-629, S-3.0 and S-0.580 (these products are of SHOWA DENKO K.K.). The detector used is a RI (refractive index) detector.

### <Production Method for the Toner>

A production method for the toner is not particularly limited and may be appropriately selected depending on the intended purpose. Preferably, the toner is granulated by dispersing an oil phase in an aqueous medium, the oil phase containing the non-crystalline polyester resin A, the non-crystalline polyester resin B, the crystalline polyester resin C, and the charge controlling agent, and if necessary, further containing the release agent, the colorant, etc.

Also, the toner is preferably granulated by dispersing an oil phase in an aqueous medium, the oil phase containing the non-linear, reactive precursor, the non-crystalline polyester resin B, the crystalline polyester resin C, and the charge controlling agent and, if necessary, further containing the curing agent, the release agent, the colorant, etc.

One example of such production methods for the toner is a known dissolution suspension method.

As one example of the production methods for the toner, a method of forming toner base particles by producing the non-crystalline polyester resin A through elongating reaction and/or cross-linking reaction between the non-linear, reactive precursor and the curing agent, is described below. This method includes preparing an aqueous medium, preparing an oil phase containing toner materials, emulsifying or dispersing the toner materials, and removing an organic solvent.

### —Preparation of Aqueous Medium (Aqueous Phase)—

The preparation of the aqueous phase can be carried out, for example, by dispersing resin particles in an aqueous medium. An amount of the resin particles in the aqueous medium is not particularly limited and may be appropriately selected depending on the intended purpose, but it is preferably 0.5 parts by mass to 10 parts by mass relative to 100 parts by mass of the aqueous medium.

The aqueous medium is not particularly limited and may be appropriately selected depending on the intended purpose. Examples thereof include water, a solvent miscible with water, and a mixture thereof. These may be used alone or in combination.

Among them, water is preferable.

The solvent miscible with water is not particularly limited and may be appropriately selected depending on the intended purpose. Examples thereof include alcohol, dimethyl formamide, tetrahydrofuran, cellosolve, and lower ketone. The alcohol is not particularly limited and may be appropriately selected depending on the intended purpose. Examples thereof include methanol, isopropanol, and ethylene glycol. The lower ketone is not particularly limited and may be appropriately selected depending on the intended purpose. Examples thereof include acetone and methyl ethyl ketone.

### —Preparation of Oil Phase—

Preparation of the oil phase containing the toner materials can be performed by dissolving or dispersing toner materials in an organic solvent, the toner materials containing at least the non-linear, reactive precursor, the non-crystalline polyester resin B, the crystalline polyester resin C, the charge controlling agent and if necessary, further containing the curing agent, the release agent, the colorant, etc.

The organic solvent is not particularly limited and may be appropriately selected depending on the intended purpose, but it is preferably an organic solvent having a boiling point of lower than 150° C., as removal thereof is easy.

The organic solvent having the boiling point of lower than 150° C. is not particularly limited and may be appropriately selected depending on the intended purpose. Examples thereof include toluene, xylene, benzene, carbon tetrachloride, methylene chloride, 1,2-dichloroethane, 1,1,2-trichloroethane, trichloroethylene, chloroform, monochlorobenzene, dichloroethylidene, methyl acetate, ethyl acetate, methyl ethyl ketone, and methyl isobutyl ketone. These may be used alone or in combination thereof.

Among them, ethyl acetate, toluene, xylene, benzene, methylene chloride, 1,2-dichloroethane, chloroform, and carbon tetrachloride are particularly preferable, and ethyl acetate is more preferable.

### —Emulsification or Dispersion—

Emulsification or dispersion of the toner materials can be performed by dispersing, in the aqueous medium, the oil phase containing the toner materials. In emulsifying or dispersing the toner materials, the curing agent and the non-linear, reactive precursor are allowed to undergo elongating reaction and/or cross-linking reaction, whereby the non-crystalline polyester resin A is formed.

The non-crystalline polyester resin A may be formed by, for example, any of methods (1) to (3) below.

(1) A method for producing the non-crystalline polyester resin A, including emulsifying or dispersing, in the aqueous medium, the oil phase containing the non-linear, reactive precursor and the curing agent, and allowing, in the aqueous medium, the curing agent and the non-linear, reactive precursor to undergo elongating reaction and/or cross-linking reaction.
(2) A method for producing the non-crystalline polyester resin A, including emulsifying or dispersing, in the aqueous medium, the oil phase containing the non-linear, reactive precursor which the curing agent has been added in advance, and allowing, in the aqueous medium, the curing agent and the non-linear, reactive precursor to undergo elongating reaction and/or cross-linking reaction.
(3) A method for producing the non-crystalline polyester resin A, including emulsifying or dispersing, in the aqueous medium, the oil phase containing the non-linear, reactive precursor, adding the curing agent to the resultant aqueous medium, and allowing, in the aqueous medium, the curing agent and the non-linear, reactive precursor to undergo elongating reaction and/or cross-linking reaction from the interfaces of the particles.

Incidentally, in the case where the curing agent and the non-linear, reactive precursor are allowed to undergo elongating reaction and/or cross-linking reaction from the interfaces of the particles, the non-crystalline polyester resin A is formed preferentially in the surfaces of the formed toner particles and as a result, a concentration gradient of the non-crystalline polyester resin A can be provided in each of the toner particles.

The reaction conditions (e.g., the reaction time and reaction temperature) for generating the non-crystalline polyester resin A are not particularly limited and may be appropriately selected depending on a combination of the curing agent and the non-linear, non-linear, reactive precursor.

The reaction time is not particularly limited and may be appropriately selected depending on the intended purpose, but it is preferably 10 minutes to 40 hours, more preferably 2 hours to 24 hours.

The reaction temperature is not particularly limited and may be appropriately selected depending on the intended purpose, but it is preferably 0° C. to 150° C., more preferably 40° C. to 98° C.

A method for stably forming a dispersion liquid containing the non-linear, reactive precursor in the aqueous medium is not particularly limited and may be appropriately selected depending on the intended purpose. Examples thereof include a method in which an oil phase, which has been prepared by dissolving and/or dispersing a toner material in a solvent, is added to a phase of an aqueous medium, followed by dispersing with shear force.

A disperser used for the dispersing is not particularly limited and may be appropriately selected depending on the intended purpose. Examples thereof include a low-speed shearing disperser, a high-speed shearing disperser, a friction disperser, a high-pressure jetting disperser and an ultrasonic wave disperser.

Among them, the high-speed shearing disperser is preferable, because it can control the particle diameters of the dispersed elements (oil droplets) to the range of 2 μm to 20 μm.

In the case where the high-speed shearing disperser is used, the conditions for dispersing, such as the rotating speed, the dispersion time, and the dispersion temperature, may be appropriately selected depending on the intended purpose.

The rotating speed is not particularly limited and may be appropriately selected depending on the intended purpose, but it is preferably 1,000 rpm to 30,000 rpm, more preferably 5,000 rpm to 20,000 rpm.

The dispersion time is not particularly limited and may be appropriately selected depending on the intended purpose, but it is preferably 0.1 minutes to 5 minutes in case of a batch system.

The dispersion temperature is not particularly limited and may be appropriately selected depending on the intended purpose, but it is preferably 0° C. to 150° C., more preferably 40° C. to 98° C. under pressure. Note that, generally speaking, dispersion can be easily carried out, as the dispersion temperature is higher.

An amount of the aqueous medium used for the emulsification or dispersion of the toner material is not particularly limited and may be appropriately selected depending on the intended purpose, but it is preferably 50 parts by mass to 2,000 parts by mass, more preferably 100 parts by mass to 1,000 parts by mass, relative to 100 parts by mass of the toner material.

When the amount of the aqueous medium is less than 50 parts by mass, the dispersion state of the toner material is impaired, which may result a failure in attaining toner base particles having desired particle diameters. When the amount thereof is greater than 2,000 parts by mass, the production cost may increase.

When the oil phase containing the toner material is emulsified or dispersed, a dispersant is preferably used for the purpose of stabilizing dispersed elements, such as oil droplets, and gives a shape particle size distribution as well as giving desirable shapes of toner particles.

The dispersant is not particularly limited and may be appropriately selected depending on the intended purpose. Examples thereof include a surfactant, a water-insoluble inorganic compound dispersant, and a polymer protective colloid. These may be used alone or in combination thereof.

Among them, the surfactant is preferable.

The surfactant is not particularly limited and may be appropriately selected depending on the intended purpose. Examples thereof include an anionic surfactant, a cationic surfactant, a nonionic surfactant, and an amphoteric surfactant.

The anionic surfactant is not particularly limited and may be appropriately selected depending on the intended purpose. Examples thereof include alkyl benzene sulfonic acid salts, α-olefin sulfonic acid salts and phosphoric acid esters.

Among them, those having a fluoroalkyl group are preferable.

In cases where the non-crystalline polyester resin A is generated, a catalyst can be used for a chain-elongation reaction and/or cross-linking reaction.

The catalyst is not particularly limited and may be appropriately selected depending on the intended purpose. Examples thereof include dibutyltin laurate and dioctyltin laurate.

### —Removal of Organic Solvent—

A method for removing the organic solvent from the dispersion liquid such as the emulsified slurry is not particularly limited and may be appropriately selected depending on the intended purpose. Examples thereof include: a method in which an entire reaction system is gradually heated to evaporate out the organic solvent in the oil droplets; and a method in which the dispersion liquid is sprayed in a dry atmosphere to remove the organic solvent in the oil droplets.

As the organic solvent removed, toner base particles are formed. The toner base particles can be subjected to washing and drying, and can be further subjected to classification. The classification may be carried out in a liquid by removing small particles by cyclone, a decanter, or centrifugal separator, or may be performed on particles after drying.

### —Washing—

A method for washing the toner is not particularly limited and may be appropriately selected depending on the intended purpose. Examples thereof preferably include a method where the toner is washed with alkaline, water, and acid.

When the toner is washed with alkaline, an emulsifier, a dispersant, and ionic impurities remaining on the surface of the toner particle can be removed.

In particular, resin particles are used as a dispersion (emulsification) stabilizer in toner particles containing at least the non-crystalline polyester resin A, in order to have a sharp particle diameter distribution. When an excessive amount of the resin particles present on the toner surface, fixing ability may be inhibited and the resultant toner may deteriorate charging ability. Accordingly, it is preferable to remove an excessive amount of the resin particles.

In this respect, the resin particles contain an acid component, and thus they are swollen or dissolved by washing with alkaline, to thereby remove them with ease.

Also, for example, the amines are used for producing the non-crystalline polyester resin A. However, an unreacted amine forms an associate with an acid group (carboxyl acid) in the non-crystalline polyester resin A, and thus an elongation reaction may not be smoothly proceed after emulsification. Moreover, it may lower an acidity of the non-crystalline polyester resin A, the resultant toner may deteriorate charging ability, and may deteriorate adhesiveness with paper.

In this respect, when the toner is washed with alkaline, a hydrogen atom of a terminal carboxyl group in the non-crystalline polyester resin A is substituted with a Na atom. After that, the resultant toner is washed with acid, and thus the terminal carboxyl group in the non-crystalline polyester resin A is formed again. Thus the elongation reaction can be allowed to proceed again.

The obtained toner base particles may be mixed with particles such as the external additive. By applying a mechanical impact during the mixing, the particles such as the external additive can be prevented from fall off from surfaces of the toner base particles.

A method for applying the mechanical impact is not particularly limited and may be appropriately selected depending on the intended purpose. Examples thereof include: a method for applying impulse force to a mixture by a blade rotating at high speed; a method for adding a mixture into a high-speed air flow and accelerating the speed of the flow to thereby make the particles crash into other particles, or make the composite particles crush into an appropriate impact board.

A device used for this method is appropriately selected depending on the intended purpose without any limitation, and examples thereof include ANGMILL (product of Hosokawa Micron Corporation), an apparatus produced by modifying I-type mill (product of Nippon Pneumatic Mfg. Co., Ltd.) to reduce the pulverizing air pressure, a hybridization system (product of Nara Machinery Co., Ltd.), a kryptron system (product of Kawasaki Heavy Industries, Ltd.) and an automatic mortar.

### (Developer)

A developer of the present invention contains at least the toner and a carrier, and further contains other components, if necessary.

Accordingly, the developer has excellent transfer properties, and charging ability, and can stably form high quality images. Note that, the developer may be a one-component developer, or a two-component developer, but it is preferably a two-component developer when it is used in a high speed printer corresponding to recent high information processing speed, because the service life thereof can be improved.

In the case where the developer is used as a one-component developer, the diameters of the toner particles do not vary largely even when the toner is supplied and consumed repeatedly, the toner does not cause filming to a developing roller, nor fuse to a layer thickness regulating member such as a blade for thinning a thickness of a layer of the toner, and provides excellent and stable developing ability and image even when it is stirred in the developing device over a long period of time.

In the case where the developer is used as a two-component developer, the diameters of the toner particles in the developer do not vary largely even when the toner is supplied and consumed repeatedly, and the toner can provide excellent and stabile developing ability even when the toner is stirred in the developing device over a long period of time.

### <Carrier>

The carrier is not particularly limited and may be appropriately selected depending on the intended purpose, but it is preferably a carrier containing a core, and a resin layer covering the core.

### —Core—

A material of the core is appropriately selected depending on the intended purpose without any limitation, and examples thereof include a 50 emu/g to 90 emu/g manganese-strontium (Mn—Sr) material, and a 50 emu/g to 90 emu/g manganese-magnesium (Mn—Mg) material. To secure a sufficient image density, use of a hard magnetic material such as iron powder (100 emu/g or higher), and magnetite (75 emu/g to 120 emu/g) is preferable. Moreover, use of a soft magnetic material such as a 30 emu/g to 80 emu/g copper-zinc material is preferable because an impact applied to a photoconductor by the developer born on a bearing member in the form of a brush can be reduced, which is an advantageous for improving image quality.

These may be used alone or in combination thereof.

The volume average particle diameter of the core is not particularly limited and may be appropriately selected depending on the intended purpose, but it is preferably 10 μm to 150 μm, more preferably 40 μm to 100 μm. When the volume average particle diameter thereof is less than 10 μm, the proportion of particles in the distribution of carrier particle diameters increases, causing carrier scattering because of low magnetization per carrier particle. When the volume average particle diameter thereof is greater than 150 μm, the specific surface area reduces, which may cause toner scattering, causing reproducibility especially in a solid image portion in a full color printing containing many solid image portions.

In the case where the toner is used for a two-component developer, the toner is used by mixing with the carrier. An amount of the carrier in the two-component developer is not particularly limited and may be appropriately selected depending on the intended purpose, but it is preferably 90 parts by mass to 98 parts by mass, more preferably 93 parts by mass to 97 parts by mass, relative to 100 parts by mass of the two-component developer.

The developer of the present invention may be suitably used in image formation by various known electrophotographies such as a magnetic one-component developing method, a non-magnetic one-component developing method, and a two-component developing method.

### (Developer Accommodating Container)

A developer accommodating container of the present invention accommodates the developer of the present invention. The container thereof is not particularly limited and may be appropriately selected from known containers. Examples thereof include those having a cap and a container main body.

The size, shape, structure and material of the container main body are not particularly limited. The container main body preferably has, for example, a hollow-cylindrical shape. Particularly preferably, it is a hollow-cylindrical body whose inner surface has spirally-arranged concavo-convex portions some or all of which can accordion and in which the developer accommodated can be transferred to an outlet port through rotation. The material for the developer-accommodating container is not particularly limited and is preferably those from which the container main body can be formed with high dimensional accuracy. Examples thereof include polyester resins, polyethylene resins, polypropylene resins, polystyrene resins, polyvinyl chloride resins, polyacrylic acids, polycarbonate resins, ABS resins and polyacetal resins.

The above developer accommodating container has excellent handleability; i.e., is suitable for storage, transportation, and is suitably used for supply of the developer with being detachably mounted to, for example, the below-described process cartridge and image forming apparatus.

### (Image Forming Apparatus and Image Forming Method)

An image forming apparatus of the present invention includes at least an electrostatic latent image bearer (hereinafter may be referred to as a “photoconductor”), an electrostatic latent image forming unit, and a developing unit, and if necessary, further includes other units.

An image forming method of the present invention includes at least an electrostatic latent image forming step and a developing step, and if necessary, further includes other steps.

The image forming method can suitably be performed by the image forming apparatus, the electrostatic latent image forming step can suitably be performed by the electrostatic latent image forming unit, the developing step can suitably be performed by the developing unit, and the other steps can suitably be performed by the other units.

### <Electrostatic Latent Image Bearer>

The material, structure, and size of the electrostatic latent image bearer are not particularly limited and may be appropriately selected from those known in the art. Regarding the material, the electrostatic latent image bearer is, for example, an inorganic photoconductor made of amorphous silicon or selenium, or an organic photoconductor made of polysilane or phthalopolymethine. Among them, an amorphous silicon photoconductor is preferred since it has a long service life.

The amorphous silicon photoconductor may be, for example, a photoconductor having a support and an electrically photoconductive layer of a-Si, which is formed on the support heated to 50° C. to 400° C. with a film forming method such as vacuum vapor deposition, sputtering, ion plating, thermal CVD (Chemical Vapor Deposition), photo-CVD or plasma CVD. Among them, plasma CVD is suitably employed, in which gaseous raw materials are decomposed through application of direct current or high-frequency or microwave glow discharge to form an a-Si deposition film on the support.

The shape of the electrostatic latent image bearer is not particularly limited and may be appropriately selected depending on the intended purpose, but it is preferably a hollow-cylindrical shape. The outer diameter of the electrostatic latent image bearer having a hollow-cylindrical shape is not particularly limited and may be appropriately selected depending on the intended purpose, but it is preferably 3 mm to 100 mm, more preferably 5 mm to 50 mm, particularly preferably 10 mm to 30 mm.

### <Electrostatic Latent Image Forming Unit and Electrostatic Latent Image Forming Step>

The electrostatic latent image forming unit is not particularly limited and may be appropriately selected depending on the intended purpose so long as it is a unit configured to form an electrostatic latent image on the electrostatic latent image bearer. Examples thereof include a unit including at least a charging member configured to charge a surface of the electrostatic latent image bearer and an exposing member configured to imagewise expose the surface of the electrostatic latent image bearer to light.

The electrostatic latent image forming step is not particularly limited and may be appropriately selected depending on the intended purpose so long as it is a step of forming an electrostatic latent image on the electrostatic latent image bearer. The electrostatic latent image forming step can be performed using the electrostatic latent image forming unit by, for example, charging a surface of the electrostatic latent image bearer and then imagewise exposing the surface thereof to light.

### <<Charging Member and Charging>>

The charging member is not particularly limited and may be appropriately selected depending on the intended purpose. Examples thereof include contact-type charging devices known per se having, for example, an electrically conductive or semiconductive roller, brush, film and rubber blade; and non-contact-type charging devices utilizing corona discharge such as corotron and scorotron.

The charging can be performed by, for example, applying voltage to the surface of the electrostatic latent image bearer by using the charging member.

The charging member may have any shape like a charging roller as well as a magnetic brush or a fur brush. The shape of the charging member may be suitably selected according to the specification or configuration of the image forming apparatus.

When the magnetic brush is used as the charging member, the magnetic brush contains various ferrite particles such as, for example, Zn—Cu ferrite; a non-magnetic conducting sleeve configured to support the particles; and a magnet roll enclosed in the non-magnetic conducting sleeve.

When the fur brush is used as the charging member, a fur subjected to electroconduction treatment by for example, carbon, copper sulfide, metal, or metal oxide, is used as the materials of the fur brush. Then, a charging member can be formed by winding a metal or another cored bar subjected to electroconduction treatment with the aforementioned fur.

The charging member is not limited to the aforementioned contact-type charging members. However, the contact-type charging members are preferably used from the viewpoint of producing an image forming apparatus in which the amount of ozone generated from the charging members is reduced.

### <<Exposing Member and Exposure>>

The exposing member is not particularly limited and may be appropriately selected depending on the purpose so long as it attains desired imagewise exposure on the surface of the electrophotographic latent image bearer charged with the charging member. Examples thereof include various exposing members such as a copy optical exposing device, a rod lens array exposing device, a laser optical exposing device, and a liquid crystal shutter exposing device.

A light source used for the exposing member is not particularly limited and may be appropriately selected depending on the intended purpose. Examples thereof include conventional light-emitting devices such as a fluorescent lamp, a tungsten lamp, a halogen lamp, a mercury lamp, a sodium lamp, a light-emitting diode (LED), a laser diode (LD) and an electroluminescence (EL) device.

Also, various filters may be used for emitting only light having a desired wavelength range. Examples of the filters include a sharp-cut filter, a band-pass filter, an infrared cut filter, a dichroic filter, an interference filter and a color temperature conversion filter.

The exposure can be performed by, for example, imagewise exposing the surface of the electrostatic latent image bearer to light using the exposing member.

In the present invention, light may be imagewise applied from the side facing the support of the electrostatic latent image bearer.

### <Developing Unit and Developing Step>

The developing unit is not particularly limited and may be appropriately selected depending on the intended purpose so long as it is a developing unit containing a toner for developing the electrostatic latent image formed on the electrostatic latent image bearer to thereby form a visible image.

The developing step is not particularly limited and may be appropriately selected depending on the intended purpose so long as it is a step of developing the electrostatic latent image formed on the electrostatic latent image bearer with a toner, to thereby form a visible image. The developing step can be performed by the developing unit.

The developing unit may employ a dry or wet developing process, and may be a single-color or multi-color developing unit.

The developing unit is preferably a developing device containing: a stirring device for charging the toner with friction generated during stirring; a magnetic field-generating unit fixed inside; and a developer bearing member configured to bear a developer containing the toner on a surface thereof and to be rotatable.

In the developing unit, toner particles and carrier particles are stirred and mixed so that the toner particles are charged by friction generated therebetween. The charged toner particles are retained in the chain-like form on the surface of the rotating magnetic roller to form magnetic brushes. The magnetic roller is disposed proximately to the electrostatic latent image developing member and thus, some of the toner particles forming the magnetic brushes on the magnet roller are transferred onto the surface of the electrostatic latent image developing member by the action of electrically attractive force. As a result, the electrostatic latent image is developed with the toner particles to form a visual toner image on the surface of the electrostatic latent image developing member.

### <Other Units and Other Steps>

Examples of the other units include a transfer unit, a fixing unit, a cleaning unit, a charge-eliminating unit, a recycling unit, and a controlling unit.

Examples of the other step include a transfer step, a fixing step, a cleaning step, a charge-eliminating step, a recycling step, and a controlling step.

### <<Transfer Unit and Transfer Step>>

The transfer unit is not particularly limited and may be appropriately selected depending on the intended purpose so long as it is a unit configured to transfer the visible image onto a recording medium. Preferably, the transfer unit includes: a primary transfer unit configured to transfer the visible images to an intermediate transfer member to form a composite transfer image; and a secondary transfer unit configured to transfer the composite transfer image onto a recording medium.

The transfer step is not particularly limited and may be appropriately selected depending on the intended purpose so long as it is a step of transferring the visible image onto a recording medium. In this step, preferably, the visible images are primarily transferred to an intermediate transfer member, and the thus-transferred visible images are secondarily transferred to the recording medium.

For example, the transfer step can be performed using the transfer unit by charging the photoconductor with a transfer charger to transfer the visible image.

Here, when the image to be secondarily transferred onto the recording medium is a color image of several color toners, a configuration can be employed in which the transfer unit sequentially superposes the color toners on top of another on the intermediate transfer member to form an image on the intermediate transfer member, and the image on the intermediate transfer member is secondarily transferred at one time onto the recording medium by the intermediate transfer unit.

The intermediate transfer member is not particularly limited and may be appropriately selected from known transfer members depending on the intended purpose. For example, the intermediate transfer member is preferably a transferring belt.

The transfer unit (including the primary- and secondary transfer units) preferably includes at least a transfer device which transfers the visible images from the photoconductor onto the recording medium. Examples of the transfer device include a corona transfer device employing corona discharge, a transfer belt, a transfer roller, a pressing transfer roller and an adhesive transferring device.

The recording medium is not particularly limited and may be appropriately selected depending on the purpose, so long as it can receive a developed, unfixed image. Examples of the recording medium include plain paper and a PET base for OHP, with plain paper being used typically.

### <<Fixing Unit and Fixing Step>>

The fixing unit is not particularly limited and may be appropriately selected depending on the intended purpose as long as it is a unit configured to fix a transferred image which has been transferred on the recording medium, but is preferably known heating-pressurizing members. Examples thereof include a combination of a heat roller and a press roller, and a combination of a heat roller, a press roller and an endless belt.

The fixing step is not particularly restricted and may be appropriately selected according to purpose, as long as it is a step of fixing a visible image which has been transferred on the recording medium. The fixing step may be performed every time when an image of each color toner is transferred onto the recording medium, or at one time (at the same time) on a laminated image of color toners.

The fixing step can be performed by the fixing unit.

The heating-pressurizing member usually performs heating preferably at 80° C. to 200° C.

Notably, in the present invention, known photofixing devices may be used instead of or in addition to the fixing unit depending on the intended purpose.

A surface pressure at the fixing step is not particularly limited and may be appropriately selected depending on the intended purpose, but is preferably 10 N/cm² to 80 N/cm².

### <<Cleaning Unit and Cleaning Step>>

The cleaning unit is not particularly limited and may be appropriately selected depending on the intended purpose, as long as it can remove the toner remaining on the photoconductor. Examples thereof include a magnetic brush cleaner, an electrostatic brush cleaner, a magnetic roller cleaner, a blade cleaner, a brush cleaner and a web cleaner.

The cleaning step is not particularly limited and may be appropriately selected depending on the intended purpose, as long as it is a step of removing the toner remaining on the photoconductor. It may be performed by the cleaning unit.

### <<Charge-Eliminating Unit and Charge-Eliminating Step>>

The charge-eliminating unit is not particularly limited and may be appropriately selected depending on the intended purpose, as long as it is a unit configured to apply a charge-eliminating bias to the photoconductor to thereby charge-eliminate. Examples thereof include a charge-eliminating lamp.

The charge-eliminating step is not particularly limited and may be appropriately selected depending on the intended purpose, as long as it is a step of applying a charge-eliminating bias to the photoconductor to thereby charge-eliminate. It may be carried out by the charge-eliminating unit.

### <<Recycling Unit and Recycling Step>>

The recycling unit is not particularly limited and may be appropriately selected depending on the intended purpose, as long as it is a unit configured to recycle the toner which has been removed at the cleaning step to the developing device. Example thereof includes a known conveying unit.

The recycling step is not particularly limited and may be appropriately selected depending on the intended purpose, as long as it is a step of recycling the toner which has been removed at the cleaning step to the developing device. The recycling step can be performed by the recycling unit.

### <<Control Unit and Control Step>>

The control unit is not particularly limited and may be appropriately selected depending on the intended purpose, as long as it can control the operation of each of the above units. Examples thereof include devices such as sequencer and computer.

The control step is not particularly limited and may be appropriately selected depending on the intended purpose, as long as it is a step of controlling the operation of each of the above units. The control step can be performed by the control unit.

One example of an image forming apparatus of the present invention will be explained with reference to FIGS.

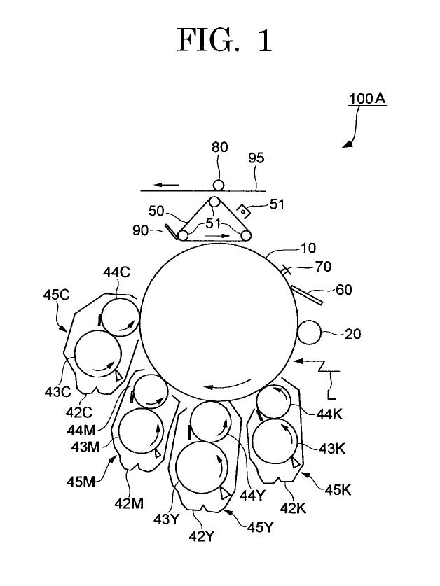

FIG. 1 illustrates one example of an image forming apparatus of the present invention. The image forming apparatus 100A in FIG. 1 contains a drum-shaped electrostatic latent image bearer 10 serving as an electrostatic latent image bearer, a charging roller 20 serving as a charging unit, an exposing device (not illustrated) serving as an exposing unit, developing devices 45 (K, Y, M, C) serving as a developing unit, an intermediate transfer member 50, a cleaning device 60 containing a cleaning blade serving as a cleaning unit, and a charge-eliminating lamp 70 serving as a charge-eliminating unit.

The intermediate transfer member 50, which is an endless belt, is stretched around three rollers disposed in the belt, and is movable in a direction indicated by the arrow in FIGs. A part of the three rollers 51 also functions as a transfer bias roller which can apply a predetermined transfer bias (primary transfer bias) to the intermediate transfer member 50.

Also, a cleaning device 90 containing a cleaning blade is disposed near the intermediate transfer member 50. Further, a transfer roller 80 serving as a transfer unit which can apply a transfer bias onto transfer paper 95 for transferring (secondary transferring) a toner image is disposed facing the intermediate transfer member 50.

In addition, around the intermediate transfer member 50, a corona charging device 52 for applying a charge to the toner image on the intermediate transfer member 50 is disposed between a contact portion of the electrostatic latent image bearers 10 with the intermediate transfer member 50 and a contact portion of the intermediate transfer member 50 with the recording paper 95.

Each of the developing devices 45 of black (K), yellow (Y), magenta (M), and cyan (C) is equipped with a developer containers 42 (K, Y, M, or C), a developer supply roller 43, and a developing roller 44.

In the image forming apparatus 100A, the image bearer 10 is uniformly charged by the charging roller 20, and then the exposing unit (not illustrated) imagewise exposes an exposing light L on the electrostatic latent image bearer 10, to thereby form an electrostatic latent image. Next, the electrostatic latent image formed on the electrostatic latent image bearer 10 is developed by supplying a developer from the developing device 45, to thereby form a toner image. Then, the toner image is transferred (primarily transferred) onto the intermediate transfer member 50 by a transfer bias applied from the roller 51. Further, the toner image on the intermediate transfer member 50 is provided with charge by the corona charging device 52, and then is transferred (secondarily transferred) on the recording paper 95. Note that, a residual toner remaining on the electrostatic latent image bearer 10 is removed by the cleaning device 60, and the electrostatic latent image bearer 10 is once charge-eliminated by the charge-eliminating lamp 70.

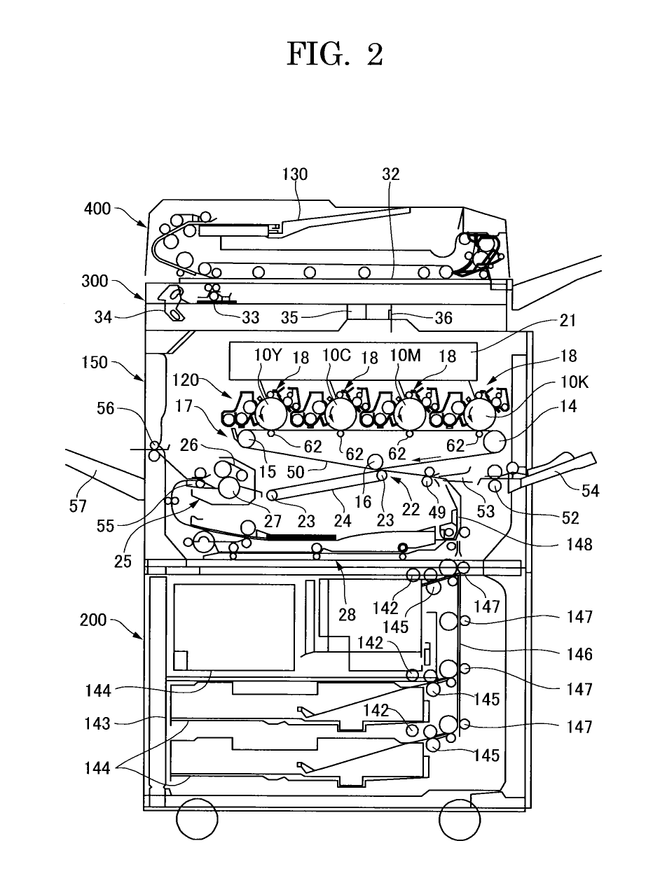

The color image forming apparatus illustrated in FIG. 2 includes a copying device main body 150, a paper feeding table 200, a scanner 300 and an automatic document feeder (ADF) 400.

An intermediate transfer member 50, which is an endless belt type, is disposed at a central part of the copying device main body 150. The intermediate transfer member 50 is stretched around support rollers 14, 15 and 16 and can rotate in a clockwise direction in FIG. 2. Near the support roller 15, a cleaning device for the intermediate transfer member 17 is disposed to remove a residual toner remaining on the intermediate transfer member 50. On the intermediate transfer member 50 stretched around the support rollers 14 and 15, a tandem type developing device 120 is disposed in which four image forming units 18 of yellow, cyan, magenta and black are arranged in parallel so as to face to each other along a conveying direction thereof. The exposing device 21 serving as the exposing member is disposed in proximity to the tandem type developing device 120. Further, a secondary transfer device 22 is disposed on a side of the intermediate transfer member 50 opposite to the side on which the tandem type developing device 120 is disposed. In the secondary transfer device 22, the secondary transfer belt 24 which is an endless belt is stretched around a pair of rollers 23, and the transfer paper conveyed on the secondary transfer belt 24 and the intermediate transfer member 50 may contact with each other. Here, a fixing device 25 serving as the fixing unit is disposed in proximity to the secondary transfer device 22. The fixing device 25 includes a fixing belt 26 which is an endless belt and a press roller 27 which is disposed so as to be pressed against the fixing belt.

Here, in the tandem type image forming apparatus, a sheet inverting device 28 is disposed near the secondary transfer device 22 and the fixing device 25 for inverting the transfer paper in the case of forming images on both sides of the transfer paper.

Next, a method for forming a full-color image (color-copying) using the tandem type developing device 120 will be explained. First, a color document is set on a document table 130 of the automatic document feeder (ADF) 400. Alternatively, the automatic document feeder 400 is opened, the color document is set on a contact glass 32 of the scanner 300, and the automatic document feeder 400 is closed.

When a start button (not illustrated) is pressed, the scanner 300 activates after the color document is conveyed and moved to the contact glass 32 in the case the color document has been set on the automatic document feeder 400, or right away in the case the color document has been set on the contact glass 32, so that a first travelling body 33 and a second travelling body 34 travel. At this time, a light is irradiated from a light source in the first travelling body 33, the light reflected from a surface of the document is reflected by a mirror in the second travelling body 34 and then is received by a reading sensor 36 through an imaging forming lens 35. Thus, the color document (color image) is read to thereby form black, yellow, magenta and cyan image information.

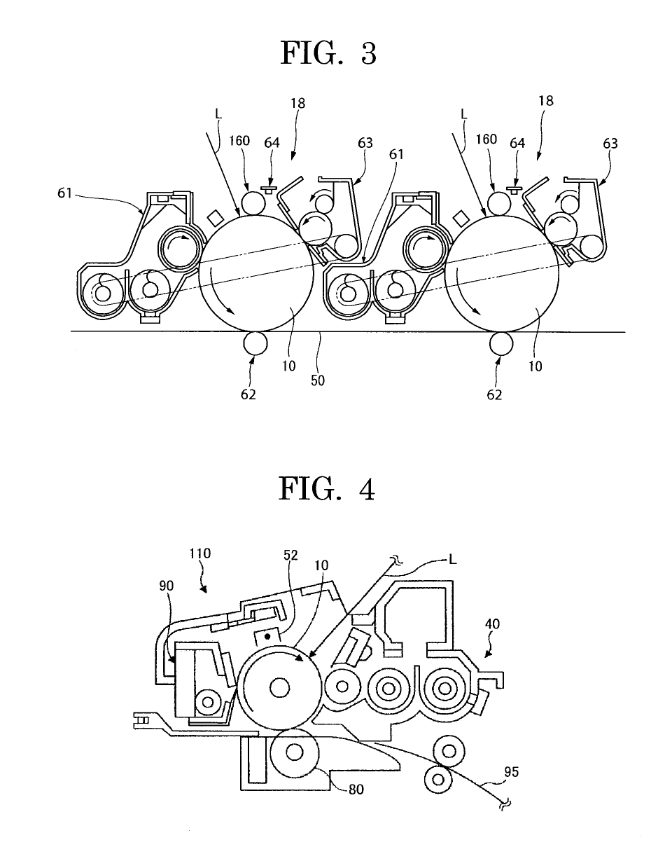

The image information of black, yellow, magenta, and cyan are transmitted to the image forming units 18 (black image forming unit, yellow image forming unit, magenta image forming unit, and cyan image forming unit) in the tandem type developing device 120, and toner images of black, yellow, magenta, and cyan are formed in the image forming units. As illustrated in FIG. 3, the image forming units 18 (black image forming unit, yellow image forming unit, magenta image forming unit, and cyan image forming unit) in the tandem type developing device 120 include: electrostatic latent image bearers 10 (black electrostatic latent image bearer 10K, yellow electrostatic latent image bearer 10Y, magenta electrostatic latent image bearer 10M, and cyan electrostatic latent image bearer 10C); a charging device 160 configured to uniformly charge the electrostatic latent image bearers 10; an exposing device configured to imagewise expose to a light (L illustrated in FIG. 3) the electrostatic latent image bearers based on color image informations to form an electrostatic latent image corresponding to color images on the electrostatic latent image bearers; a developing device 61 configured to develop the electrostatic latent images with color toners (black color toner, yellow color toner, magenta color toner, and cyan color toner) to form a toner image of the color toners; a transfer charger 62 configured to transfer the toner image onto the intermediate transfer member 50; a cleaning device 63; and a charge-eliminating unit 64. Each image forming unit 18 can form monochrome images (black image, yellow image, magenta image, and cyan image) based on image formations of colors. Thus formed black image (i.e., black image formed onto the black electrostatic latent image bearer 10K), yellow image (i.e., yellow image formed onto the yellow electrostatic latent image bearer 10Y), magenta image (i.e., magenta image formed onto the magenta electrostatic latent image bearer 10M), and cyan image (i.e., cyan image formed onto the cyan electrostatic latent image bearer 10C) are sequentially transferred (primarily transferred) onto the intermediate transfer member 50 which is rotatably moved by the support rollers 14, 15 and 16. The black image, the yellow image, the magenta image, and the cyan image are superposed on the intermediate transfer member 50 to thereby form a composite color image (color transfer image).

Meanwhile, on the paper feeding table 200, one of paper feeding rollers 142 is selectively rotated to feed a sheet (recording paper) from one of the paper feeding cassettes 144 equipped in multiple stages in a paper bank 143. The sheet is separated one by one by a separation roller 145 and sent to a paper feeding path 146. The sheet (recording paper) is conveyed by a conveying roller 147 and is guided to a paper feeding path 148 in the copying device main body 150, and stops by colliding with a registration roller 49. Alternatively, a paper feeding roller 142 is rotated to feed a sheet (recording paper) on a manual feed tray 54. The sheet (recording paper) is separated one by one by a separation roller 52 and is guided to a manual paper feeding path 53, and stops by colliding with the registration roller 49. Notably, the registration roller 49 is generally used while grounded, but it may also be used in a state that a bias is being applied for removing paper dust on the sheet. Next, by rotating the registration roller 49 in accordance with the timing of the composite toner image (color transferred image) formed on the intermediate transfer member 50, the sheet (recording paper) is fed to between the intermediate transfer member 50 and the secondary transfer device 22. Thereby, the composite toner image (color transferred image) is transferred (secondarily transferred) by the secondary transfer device 22 onto the sheet (recording paper) to thereby form a color image on the sheet (recording paper). Notably, a residual toner remaining on the intermediate transfer member 50 after image transfer is removed by the cleaning device for the intermediate transfer member 17.

The sheet (recording paper) on which the color image has been transferred is conveyed by the secondary transfer device 22, and then conveyed to the fixing device 25. In the fixing device 25, the composite color image (color transferred image) is fixed on the sheet (recording paper) by the action of heat and pressure. Next, the sheet (recording paper) is switched by a switching claw 55, and discharged by a discharge roller 56 and stacked in a paper ejection tray 57. Alternatively, the sheet is switched by the switching claw 55, and is inverted by the inverting device 28 to thereby be guided to a transfer position again. After an image is formed similarly on the rear surface, the recording paper is discharged by the discharge roller 56 stacked in the paper ejection tray 57.

### (Process Cartridge)

A process cartridge of the present invention is molded so as to be mounted to various image forming apparatuses in an attachable and detachable manner, including at least an electrostatic latent image bearer; and a developing unit containing a toner and configured to develop the electrostatic latent image formed on the electrostatic latent image bearer to thereby form a visible image. Note that, the process cartridge of the present invention may further include other units, if necessary.

FIG. 4 illustrates one example of the process cartridge of the present invention. A process cartridge 110 includes a photoconductor drum 10, a corona charging device 52, a developing device 40, a transfer roller 80, and a cleaning device 90.

### EXAMPLES

The present invention will be described by way of Examples below. The present invention should not be construed as being limited to the Examples. Unless otherwise specified, “part(s)” means “part(s) by mass”, and “%” means “% by mass”.

Each of the measurement values described below was measured by the methods described in the present specification.

### <Preparation of Charge Controlling Agent Dispersion Liquid 1>

FTERGENT 209F was added to ethyl acetate so that its active ingredient was a concentration of 20% relative to ethyl acetate, followed by stirring 0.5 hours, to thereby obtain [charge controlling agent dispersion liquid 1].

### <Preparation of Charge Controlling Agent Dispersion Liquids 2 to 6>

Charge controlling agent dispersion liquids 2 to 6 were obtained in the same manner as in the preparation of charge controlling agent dispersion liquid 1 except that the charge controlling agents was changed to those shown in Table 1.

TABLE 1

| | Charge controlling agent | Polarity | Structure |
|---|---|---|---|
| 1 | FTERGENT 209F | Nonionic | Polyoxyethylene ether |
| 2 | FTERGENT 212P | Nonionic | Polyoxyethylene ether |
| 3 | FTERGENT 710FM | Nonionic | Oligomer |
| 4 | FTERGENT 220P | Nonionic | Polyoxyethylene ether |
| 5 | FTERGENT 310 | Cationic | Quaternary ammonium salt |
| 6 | FTERGENT 250 | Nonionic | Polyoxyethylene ether |

FTERGENT 209F, FTERGENT 212P, FTERGENT 710FM, FTERGENT 220P, FTERGENT 310, and FTERGENT 250 are products of Neos Company Ltd.

### Production Example 1

### Synthesis of Ketimine

A reaction container equipped with a stirring rod and a thermometer was charged with isophorone diisocyanate (170 parts) and methyl ethyl ketone (75 parts), followed by reaction at 50° C. for 5 hours, to thereby obtain [ketimine compound 1]. The amine value of the obtained [ketimine compound 1] was found to be 418.

### Production Example A1

### Synthesis of Non-Crystalline Polyester Resin A1

### —Synthesis of Prepolymer A1—

A reaction vessel equipped with a condenser, a stirring device, and a nitrogen-introducing tube was charged with 3-methyl-1,5-pentanediol, isophthalic acid, adipic acid, and trimethylolpropane so that a ratio by mole of hydroxyl group to carboxyl group “OH/COOH” was 1.5, a diol component was composed of 100% by mole of 3-methyl-1,5-pentanediol, a dicarboxylic acid component was composed of 40% by mole of isophthalic acid and 60% by mole of adipic acid, and an amount of trimethylolpropane was 1% by mole relative to the total amount of the monomers. Moreover, titanium tetraisopropoxide (1,000 ppm relative to the resin component) was added thereto. Thereafter, the resultant mixture was heated to 200° C. for about 4 hours, then heated to 230° C. for 2 hours, and allowed to react until no flowing water was formed. Thereafter, the reaction mixture was allowed to further react for 5 hours under a reduced pressure of 10 mmHg to 15 mmHg, to thereby produce intermediate polyester A1.

Next, a reaction vessel equipped with a condenser, a stirring device, and a nitrogen-introducing tube was charged with the obtained intermediate polyester A1 and isophorone diisocyanate (IPDI) at a ratio by mole of 2.0 (as the isocyanate group of the IPDI/the hydroxyl group of the intermediate polyester). The resultant mixture was diluted with ethyl acetate so as to be a 50% ethyl acetate solution, followed by reaction at 100° C. for 5 hours, to thereby produce prepolymer A1.

### —Synthesis of Non-Crystalline Polyester Resin A1—

The obtained prepolymer A1 was stirred in a reaction vessel equipped with a heating device, a stirring device, and a nitrogen-introducing tube. The [ketimine compound 1] was added dropwise to the reaction vessel in such an amount that the amount by mole of amine in the [ketimine compound 1] was equal to the amount by mole of isocyanate in the prepolymer A1. The reaction mixture was stirred at 45° C. for 10 hours, and then the polymer product extended was taken out. The obtained polymer product extended was dried at 50° C. under reduced pressure until the amount of the remaining ethyl acetate was 100 ppm or less, to thereby obtain non-crystalline polyester resin A1.

### Production Example A2

### Synthesis of Non-Crystalline Polyester Resin A2

### —Synthesis of Prepolymer A2—

A reaction vessel equipped with a condenser, a stirring device, and a nitrogen-introducing tube was charged with bisphenol A ethylene oxide 2 mole adduct, 3-methyl-1,5-pentanediol, isophthalic acid, adipic acid, and trimelltic anhydride so that a ratio by mole of hydroxyl group to carboxyl group “OH/COOH” was 1.5, a diol component was composed of 80% by mole of bisphenol A ethylene oxide 2 mole adduct and 20% by mole of 3-methyl-1,5-pentanediol, a dicarboxylic acid component was composed of 85% by mole of isophthalic acid and 15% by mole of adipic acid, and an amount of the trimellitic anhydride was 1% by mole relative to the total amount of the monomers. Moreover, titanium tetraisopropoxide (1,000 ppm relative to the resin component) was added thereto. The resultant mixture was heated to 200° C. for about 4 hours and then heated to 230° C. for 2 hours, and was allowed to react until no flowing water was formed. Thereafter, the reaction mixture was allowed to further react for 5 hours under a reduced pressure of 10 mmHg to 15 mmHg, to thereby produce intermediate polyester A2.

Next, a reaction vessel equipped with a condenser, a stirring device, and a nitrogen-introducing tube was charged with the intermediate polyester A2 and isophorone diisocyanate (IPDI) at a ratio by mole of 2.0 (as the isocyanate group of the IPDI/the hydroxyl group of the intermediate polyester). The resultant mixture was diluted with ethyl acetate so as to be a 50% ethyl acetate solution, followed by reaction at 100° C. for 5 hours, to thereby produce prepolymer A2.

### Production Examples A3 to A6

### Synthesis of Non-Linear, Non-Crystalline Polyester Resins A3 to A6

### —Synthesis of Prepolymers A3 to A6—

Prepolymers A3 to A6 were obtained in the same manner as in the synthesis of prepolymer A1 except that the diol component and the dicarboxylic acid in the synthesis of prepolymer A1 were changed to those shown in columns of A3 to A6 in Table 2.

Note that, each of the values means mixing ratio (% by mole) in the columns of the diol component and the dicarboxylic acid as shown in Table 2.

TABLE 2

| | Diol | Dicarboxylic acid |
|---|---|---|
| A1 | 3-methyl-1,5-pentanediol (100) | Isophthalic acid/adipic acid |
| | | (40/60) |
| A2 | BisAEO/3-methyl-1,5-pentanediol | Isophthalic acid/adipic acid |
| | (80/20) | (85/15) |
| A3 | BisAEO/3-methyl-1,5-pentanediol | Terephathalic acid/adipic acid |
| | (80/20) | (50/50) |
| A4 | 3-methyl-1,5-pentanediol (100) | Isophthalic acid/adipic acid |
| | | (90/10) |
| A5 | 3-methyl-1,5-pentanediol (100) | Isophthalic acid/adipic acid |
| | | (80/20) |
| A6 | 3-methyl-1,5-pentanediol (100) | Decanedioic acid (100) |

In Table 2, “BisAEO” means bisphenol A ethylene oxide 2 mole adduct.

### Production Example B1

### Synthesis of Non-Crystalline Polyester Resin B1

A four-necked flask equipped with a nitrogen-introducing tube, a dehydration tube, a stirring device, and a thermocouple was charged with bisphenol A ethylene oxide 2 mole adduct, bisphenol A propylene oxide 3 mole adduct, terephthalic acid, and adipic acid so that a ratio by mole between bisphenol A ethylene oxide 2 mole adduct and bisphenol A propylene oxide 3 mole adduct (bisphenol A ethylene oxide 2 mole adduct/bisphenol A propylene oxide 3 mole adduct) was set to 60/40; that a ratio by mole between terephthalic acid and adipic acid (terephthalic acid/adipic acid) was set to 93/7; and that a ratio by mole of hydroxyl group to carboxyl group “OH/COOH” was 1.3. Moreover, titanium tetraisopropoxide (500 ppm relative to the resin component) was added thereto, and the resultant mixture was allowed to react under normal pressure at 230° C. for 8 hours and then to further react under a reduced pressure of 10 mmHg to 15 mmHg for 4 hours. Trimellitic anhydride was added to the reaction vessel so that an amount thereof was 1% by mole relative to the total resin components, followed by reaction at 180° C. under normal pressure for 3 hours, to thereby obtain non-crystalline polyester resin B1.

### Production Examples B2 and B3

### Synthesis of Non-Crystalline Polyester Resins B2 and B3

Non-crystalline polyester resins B2 and B3 were obtained in the same manner as in the synthesis of non-crystalline polyester resin B1 except that formulations of the diol component and the dicarboxylic acid were changed to those as shown in Table 3.

Note that, each of the values means mixing ratio (% by mole) in the columns of the diol component and the dicarboxylic acid as shown in Table 3.

TABLE 3

| | Diol | Dicarboxylic acid |
|---|---|---|
| B1 | BisAPO/BisAEO (60/40) | Terephathalic acid/adipic acid (97/3) |
| B2 | BisAEO/BisAPO (75/25) | Isophthalic acid/adipic acid (70/30) |
| B3 | BisAPO/BisAEO (15/85) | Isophthalic acid/adipic acid (80/20) |

In Table 3, “BisAEO” means bisphenol A ethylene oxide 2 mole adduct, and “BisAPO” means bisphenol A propylene oxide 3 mole adduct.

### Production Example C

### Synthesis of Crystalline Polyester Resin C

A four-necked flask of 5 L equipped with a nitrogen-introducing tube, a dehydration tube, a stirring device, and a thermocouple was charged with sebacic acid and 1,6-hexanediol so that a ratio by mole of hydroxyl group to carboxyl group “OH/COOH” was 0.9. Moreover, titanium tetraisopropoxide (500 ppm relative to the resin component) was added thereto, and the resultant mixture was allowed to react under normal pressure at 180° C. for 10 hours, heated to 200° C., allowed to react 3 hours, and then to react under a pressure of 8.3 kPa for 2 hours to thereby obtain a crystalline polyester resin C.

### Example 1

### Synthesis of Master Batch (Mb)

Water (1,200 parts), 500 parts of carbon black (Printex 35, product of Evonik Degussa Japan Co., Ltd.) [DBP oil absorption amount=42 mL/100 mg, pH=9.5], and 500 parts of the non-crystalline polyester resin B1 were added and mixed together by means of HENSCHEL MIXER (product of NIPPON COLE & ENGINEERING CO., LTD.), and the resultant mixture was kneaded by means of a two roll mill for 30 minutes at 150° C. The resultant kneaded product was rolled out and cooled, followed by pulverizing by a pulverizer, to thereby obtain [master batch 1].

### <Preparation of WAX Dispersion Liquid>

A vessel to which a stirring bar and a thermometer had been set was charged with 300 parts of paraffin wax (HNP-9, product of Nippon Seiro Co., Ltd., hydrocarbon wax, melting point: 75° C.) as a release agent 1, 150 parts of wax dispersant (RSWD-A, product of Sanyo Chemical Industries, Ltd.) and 1,800 parts of ethyl acetate, followed by heating to 80° C. with stirring. The temperature was maintained at 80° C. for 5 hours, followed by cooling to 30° C. for 1 hour. The resultant mixture was dispersed by a bead mill (ULTRA VISCOMILL, product of AIMEX CO., Ltd.) under the conditions: a liquid feed rate of 1 kg/hr, disc circumferential velocity of 6 m/s, 0.5 mm-zirconia beads packed to 80% by volume, and 3 passes, to thereby obtain [WAX dispersion liquid 1].

### <Preparation of Crystalline Polyester Resin Dispersion Liquid>

A vessel to which a stirring bar and a thermometer had been set was charged with 308 parts of the crystalline polyester resin C, 1,900 parts of ethyl acetate, followed by heating to 80° C. with stirring. The temperature was maintained at 80° C. for 5 hours, followed by cooling to 30° C. for 1 hour. The resultant mixture was dispersed by a bead mill (ULTRA VISCOMILL, product of AIMEX CO., Ltd.) under the conditions: a liquid feed rate of 1 kg/hr, disc circumferential velocity of 6 m/s, 0.5 mm-zirconia beads packed to 80% by volume, and 3 passes, to thereby obtain [crystalline polyester resin dispersion liquid 1].

### <Preparation of Oil Phase>

A vessel was charged with 190 parts of the [WAX dispersion liquid 1], 32 parts of the [prepolymer A1], 290 parts of the [crystalline polyester resin dispersion liquid 1], 65 parts of the [non-crystalline polyester resin B1], 100 parts of the [master batch 1], 0.2 parts of the [ketimine compound 1], and 7 parts of the [charge controlling agent dispersion liquid 1], followed by mixing using a TK Homomixer (product of PRIMIX Corporation) at 7,000 rpm for 60 minutes, to thereby obtain [oil phase 1].

### <Synthesis of Organic Particle Emulsion (Particle Dispersion Liquid)>

A reaction vessel equipped with a stirring bar and a thermometer was charged with 683 parts of water, 11 parts of a sodium salt of sulfuric acid ester of methacrylic acid-ethylene oxide adduct (ELEMINOL RS-30, product of Sanyo Chemical Industries, Ltd.), 138 parts of styrene, 138 parts of methacrylic acid, and 1 part of ammonium persulfate, and the resultant mixture was stirred for 15 minutes at 400 rpm, to thereby obtain a white emulsion. The obtained emulsion was heated to have the system temperature of 75° C., and was then allowed to react for 5 hours. To the resultant, 30 parts of a 1% ammonium persulfate aqueous solution was added, followed by aging for 5 hours at 75° C., to thereby obtain an aqueous dispersion liquid of a vinyl resin (a copolymer of styrene/methacrylic acid/sodium salt of sulfuric acid ester of methacrylic acid ethylene oxide adduct), i.e., [particle dispersion liquid 1].

The [particle dispersion liquid 1] was measured by LA-920 (product of HORIBA, Ltd.), and as a result, the volume average particle diameter thereof was found to be 0.14 μm. A part of the [particle dispersion liquid 1] was dried, and a resin component thereof was isolated.

### <Preparation of Aqueous Phase>

Water (990 parts), 83 parts of the [particle dispersion liquid 1], 37 parts of a 48.5% aqueous solution of sodium dodecyldiphenyl ether disulfonate (ELEMINOL MON-7, product of Sanyo Chemical Industries Ltd.), and 90 parts of ethyl acetate were mixed and stirred, to thereby obtain an opaque white liquid. The obtained liquid was used as [aqueous phase 1].

### <Emulsification-Removal of Solvent>

The [aqueous phase 1] (1,200 parts) was added to a container charged with 700.2 parts of the [oil phase 1], and the resultant mixture was mixed by a TK Homomixer at 8,000 rpm for 20 minutes, to thereby obtain [emulsified slurry 1].

A container equipped with a stirrer and a thermometer was charged with the [emulsified slurry 1], followed by removing the solvent therein at 30° C. for 8 hours. Thereafter, the resultant was matured at 45° C. for 4 hours, to thereby obtain [dispersion slurry 1].

### <Washing and Drying>

After subjecting 100 parts of the [dispersion slurry 1] to filtration under the reduced pressure, the obtained cake was subjected twice to a series of treatments (1) to (4) described below, to thereby produce [filtration cake 1]:

(1): ion-exchanged water (100 parts) was added to the filtration cake, followed by mixing with a TK Homomixer (at 12,000 rpm for 10 minutes) and then filtration;

(2): 10% aqueous sodium hydroxide solution (100 parts) was added to the filtration cake obtained in (1), followed by mixing with a TK Homomixer (at 12,000 rpm for 30 minutes) and then filtration under reduced pressure;

(3): 10% by mass hydrochloric acid (100 parts) was added to the filtration cake obtained in (2), followed by mixing with a TK Homomixer (at 12,000 rpm for 10 minutes) and then filtration; and

(4): ion-exchanged water (300 parts) was added to the filtration cake obtained in (3), followed by mixing with a TK Homomixer (at 12,000 rpm for 10 minutes) and then filtration.

Next, the [filtration cake 1] was dried with an air-circulating drier at 45° C. for 48 hours, and then was caused to pass through a sieve with a mesh size of 75 μm, to thereby obtain [toner 1].

### Example 2

A toner of Example 2 was obtained in the same manner as in Example 1 except that the [charge controlling agent dispersion liquid 1] was changed to the [charge controlling agent dispersion liquid 2].

### Example 3

A toner of Example 3 was obtained in the same manner as in Example 1 except that the [charge controlling agent dispersion liquid 1] was changed to the [charge controlling agent dispersion liquid 3].

### Example 4

A toner of Example 4 was obtained in the same manner as in Example 1 except that the [charge controlling agent dispersion liquid 1] was changed to the [charge controlling agent dispersion liquid 4]; that the [prepolymer A1] was changed to the [prepolymer A3]; and that the non-crystalline polyester resin B1 was changed to the non-crystalline polyester resin B2.

### Example 5

A toner of Example 5 was obtained in the same manner as in Example 4 except that the non-crystalline polyester resin B2 was changed to the non-crystalline polyester resin BE that the [prepolymer A3] was changed to the [prepolymer A4]; and that the amount of the [charge controlling agent dispersion liquid 4] charged in the <Preparation of oil phase> was changed from 7 parts to 18 parts.

### Example 6

A toner of Example 6 was obtained in the same manner as in Example 1 except that the [prepolymer A1] was changed to the [prepolymer A2], and that the amount of the [charge controlling agent dispersion liquid 1] charged in the <Preparation of oil phase> was changed from 7 parts to 14 parts.

### Example 7

A toner of Example 7 was obtained in the same manner as in Example 1 except that the [prepolymer A1] was changed to the [prepolymer A2].

### Example 8

A toner of Example 8 was obtained in the same manner as in Example 1 except that the [prepolymer A1] was changed to the [prepolymer A4], and that the [non-crystalline polyester resin B1] was changed to the [non-crystalline polyester resin B3].

### Example 9

A toner of Example 9 was obtained in the same manner as in Example 8 except that the [prepolymer A4] was changed to the [prepolymer A5].

### Example 10

A toner of Example 10 was obtained in the same manner as in Example 1 except that the [prepolymer A1] was changed to the [prepolymer A5].

### Example 11

A toner of Example 11 was obtained in the same manner as in Example 1 except that the [charge controlling agent dispersion liquid 1] was changed to the [charge controlling agent dispersion liquid 2], and that the [prepolymer A1] was changed to the [prepolymer A6].

### Comparative Example 1

A toner of Comparative Example 1 was obtained in the same manner as in Example 1, except that the [prepolymer A1] was changed to the [prepolymer A2]; that the charge controlling agent dispersion liquid was not added to the oil phase during granulation; and that 300 parts of water and an aqueous methanol solution containing FTERGENT 310 in an amount of 1% by mass were added to the obtained [filtration cake] after washing so that the amount of FTERGENT 310 was 0.1% by mass as the charge controlling agent relative to the solid content of the [filtration cake], and the resultant mixture was mixed with a TK Homomixer (at 12,000 rpm for 10 minutes) and then filtrated.

### Comparative Example 2

A toner of Comparative Example 2 was obtained in the same manner as in Example 3 except that the amount of the [oil phase 1] was changed from 700.2 parts to 650 parts, and that the amount of the [aqueous phase 1] was changed from 1,200 parts to 1,250 parts during emulsification.

### Comparative Example 3

A toner of Comparative Example 3 was obtained in the same manner as in Example 1 except that the [charge controlling agent dispersion liquid 2] was changed to the [charge controlling agent dispersion liquid 5].

### Comparative Example 4

A toner of Comparative Example 4 was obtained in the same manner as in Example 1 except that the [charge controlling agent dispersion liquid 1] was changed to the [charge controlling agent dispersion liquid 6].

### <Evaluation>

Each of the obtained toners was used to prepare a developer as follows, and was evaluated described hereinafter. Results are shown in Tables 4 and 5.

### <<Production of Developer>>

### —Production of Carrier—

Silicone resin organostraight silicone (100 parts), 5 parts of γ-(2-aminoethyl)aminopropyltrimethoxy silane, and 10 parts of carbon black were added to 100 parts of toluene, and then, the resultant mixture was dispersed by a homomixer for 20 minutes, to thereby prepare a resin layer coating liquid. The resin layer coating liquid was applied to surfaces of spherical magnetite particles having the average particle diameter of 50 μm (1,000 parts), by a fluidized bed coating device, to thereby prepare a carrier.

### —Production of Developer—

Using a ball mill, the toner (5 parts) and the carrier (95 parts) were mixed to thereby produce a developer.

### <<Charging Ability>>

A two-component developer (6 g) was weighed and charged into a closable metal cylinder, followed by stirring at 280 rpm of a stirring speed, to thereby determine the amount of charging ability as measured by a blow-off method. Note that, the two-component developer was stirred for 15 seconds (TA15), 60 seconds (TA60), and 600 seconds (TA600). The charging ability of the two-component developer was measured after each of these stirring times. TEFV200/300 (product of Powdertech Co., Ltd) was used as a carrier. Then, the charging ability was evaluated based on the following evaluation criteria.

### [Evaluation Criteria]

A: The absolute value of the charging ability was 36 Q/M or greater.

B: The absolute value of the charging ability was 33 Q/M or greater but less than 36 Q/M.

C: The absolute value of the charging ability was 30 Q/M or greater but less than 33 Q/M.

D: The absolute value of the charging ability was less than 30 Q/M.

### <<Low Temperature Fixing Ability>>

An apparatus provided by modifying a fixing portion of copier MF2200 (product of Ricoh Company, Ltd.) using a TEFLON (registered trademark) roller as a fixing roller was used to perform a copy test on sheets of Type 6200 paper (product of Ricoh Company, Ltd.).

Specifically, the cold offset temperature (minimum fixing temperature) was determined by changing the fixing temperature.

As the evaluation conditions, the paper-feeding linear velocity was set to 120 ram/sec to 150 mm/sec, the surface pressure was set to 1.2 kgf/cm², and the nip width was set to 3 mm. The low temperature fixing ability was evaluated based on the following evaluation criteria.

### [Evaluation Criteria for Cold Offset]

A: Less than 110° C.

B: 110° C. or greater but less than 120° C.

C: 120° C. or greater but less than 130° C.

D: 130° C. or more

### <<Heat Resistant Storage Stability>>

The resultant toner was stored at 50° C. for 8 hours, and was caused to pass through a sieve of 42-mesh for 2 minutes, to thereby determine a residual rate on a wire mesh. The more excellent the heat resistant storage stability of the toner is, the smaller the residual rate is.

Note that, the evaluation criteria of the heat resistant storage stability were as follows.

### [Evaluation Criteria]

A: The residual rate is less than 15%.

B: The residual rate is 15% or greater but less than 25%.

C: The residual rate is 25% or greater but less than 35%.

D: The residual rate is 35% or more.

TABLE 4

| | The amount of | | | | | | Tg | | |
|---|---|---|---|---|---|---|---|---|---|
| | fluorine | | | | | | (insoluble | | |
| | XPS | CIC | XPS/CIC | TA15 | TA60 | TA600 | matter) | Tg1st | Tg2nd |
| | [%] | [ppm] | — | [-Q/M] | [-Q/M] | [-Q/M] | [° C.] | [° C.] | [° C.] |
| Example 1 | 5.2 | 512 | 1.01 × 10⁻² | 35 | 38 | 38 | −25 | 45 | 21 |
| Example 2 | 2.3 | 491 | 0.47 × 10⁻² | 32 | 35 | 37 | −24 | 44 | 20 |
| Example 3 | 4.8 | 350 | 1.37 × 10⁻² | 33 | 36 | 33 | −26 | 45 | 20 |
| Example 4 | 3.8 | 480 | 0.79 × 10⁻² | 33 | 34 | 33 | 28 | 47 | 29 |
| Example 5 | 7.5 | 700 | 1.08 × 10⁻² | 38 | 45 | 42 | −25 | 48 | 31 |
| Example 6 | 8.1 | 690 | 1.17 × 10⁻² | 38 | 49 | 43 | 32 | 55 | 40 |
| Example 7 | 4.2 | 510 | 0.82 × 10⁻² | 34 | 36 | 37 | 35 | 54 | 39 |
| Example 8 | 4.8 | 522 | 0.92 × 10⁻² | 34 | 36 | 36 | 5 | 21 | 3 |
| Example 9 | 4.5 | 531 | 0.84 × 10⁻² | 34 | 36 | 36 | 0 | 18 | −1 |
| Example 10 | 4.7 | 514 | 0.92 × 10⁻² | 33 | 37 | 37 | 1 | 39 | 21 |
| Example 11 | 2.8 | 490 | 0.57 × 10⁻² | 30 | 33 | 36 | −42 | 30 | 19 |
| Comparative | 6.5 | 440 | 1.48 × 10⁻² | 29 | 35 | 32 | 33 | 52 | 38 |
| Example 1 | | | | | | | | | |
| Comparative | 4.5 | 312 | 1.44 × 10⁻² | 28 | 32 | 30 | −24 | 44 | 40 |
| Example 2 | | | | | | | | | |
| Comparative | 0.9 | 49 | 1.84 × 10⁻² | 25 | 28 | 26 | −24 | 45 | 21 |
| Example 3 | | | | | | | | | |
| Comparative | 0.8 | 45 | 1.78 × 10⁻² | 22 | 25 | 23 | −25 | 45 | 21 |
| Example 4 | | | | | | | | | |

TABLE 5

| | | | | | Heat |
|---|---|---|---|---|---|
| | | | | minimum | resistant |
| | | | | fixing | storage |
| | TA15 | TA60 | TA600 | temperature | stability |
| Example 1 | B | A | A | A | A |
| Example 2 | C | B | A | A | B |
| Example 3 | B | A | B | A | B |
| Example 4 | B | B | B | B | A |
| Example 5 | A | A | A | C | A |
| Example 6 | A | A | A | C | B |
| Example 7 | B | A | A | C | C |
| Example 8 | B | A | A | A | B |
| Example 9 | B | A | A | A | A |
| Example 10 | B | A | A | A | A |
| Example 11 | C | B | A | A | B |
| Comparative | D | B | C | D | C |
| Example 1 | | | | | |
| Comparative | D | C | C | A | C |
| Example 2 | | | | | |
| Comparative | D | D | D | A | C |
| Example 3 | | | | | |
| Comparative | D | D | D | A | C |
| Example 4 | | | | | |

Embodiments of the present invention are as follows, for example.

<1> A toner,

wherein the toner satisfies a ratio XPS (%)/CIC (ppm) of 1.40×10⁻² or less, where CIC (ppm) denotes a fluorine content ratio (ppm) determined by combustion ion chromatography and XPS (%) denotes a fluorine content ratio (%) determined by X-ray photoelectron spectroscopic analysis.

<2> The toner according to <1>, wherein the toner includes a fluorine-containing compound, and the fluorine-containing compound is nonionic.

<3> The toner according to <2>, wherein the fluorine-containing compound has a polyoxyethylene ether structure.

<4> The toner according to any one of <1> to <3>, wherein [Tg2nd (THF insoluble matter)] of THF insoluble matter of the toner is −40° C. to 30° C., where the [Tg2nd (THF insoluble matter)] is a glass transition temperature measured in second heating of differential scanning calorimetry (DSC) of the THF insoluble matter.

<5> The toner according to any one of <1> to <4>, wherein a glass transition temperature (Tg1st) of the toner is 20° C. to 50° C., where the glass transition temperature (Tg1st) is measured in first heating of differential scanning calorimetry (DSC) of the toner.

<6> The toner according to any one of <1> to <5>, wherein a glass transition temperature (Tg2nd) of the toner is 0° C. to 30° C., where the glass transition temperature (Tg2nd) is measured in second heating of differential scanning calorimetry (DSC) of the toner.

<7> The toner according to any one of <1> to <6>, wherein the toner contains a polyester resin.

<8> The toner according to <7>, wherein the polyester resin contains a crystalline polyester resin.

<9> The toner according to <7> or <8>, wherein the polyester resin contains a non-linear polyester resin resin having a cross-linked structure.

<10> A developer, including:

the toner according to any one of <1> to <9>; and

a carrier.

<11> An image forming apparatus, including:

an electrostatic latent image bearer;

an electrostatic latent image forming unit configured to form an electrostatic latent image on the electrostatic latent image bearer; and

a developing unit containing a toner and configured to develop the electrostatic latent image formed on the electrostatic latent image bearer to form a visible image,

wherein the toner is the toner according to any one of <1> to <9>.

This application claims priority to Japanese application No. 2014-052694, filed on Mar. 14, 2014 and incorporated herein by reference.

What is claimed is:

1. A toner,
wherein the toner satisfies a ratio XPS (%)/CIC (ppm) of 1.40×10⁻² or less, where CIC (ppm) denotes a fluorine content ratio (ppm) determined by combustion ion chromatography and XPS (%) denotes a fluorine content ratio (%) determined by X-ray photoelectron spectroscopic analysis.

2. The toner according to claim 1, wherein the toner comprises a fluorine-containing compound, and the fluorine-containing compound is nonionic.

3. The toner according to claim 2, wherein the fluorine-containing compound has a polyoxyethylene ether structure.

4. The toner according to claim 1, wherein [Tg2nd (THF insoluble matter)] of THF insoluble matter of the toner is −40° C. to 30° C., where the [Tg2nd (THF insoluble matter)] is a glass transition temperature measured in second heating of differential scanning calorimetry (DSC) of the THF insoluble matter.

5. The toner according to claim 1, wherein a glass transition temperature (Tg1st) of the toner is 20° C. to 50° C., where the glass transition temperature (Tg1st) is measured in first heating of differential scanning calorimetry (DSC) of the toner.

6. The toner according to claim 1, wherein a glass transition temperature (Tg2nd) of the toner is 0° C. to 30° C., where the glass transition temperature (Tg2nd) is measured in second heating of differential scanning calorimetry (DSC) of the toner.

7. The toner according to claim 1, wherein the toner comprises a polyester resin.

8. The toner according to claim 7, wherein the polyester resin comprises a crystalline polyester resin.

9. The toner according to claim 7, wherein the polyester resin comprises a non-linear polyester resin resin having a cross-linked structure.

10. A developer, comprising:
a toner; and
a carrier,
wherein the toner satisfies a ratio XPS (%)/CIC (ppm) of 1.40×10⁻² or less, where CIC (ppm) denotes a fluorine content ratio (ppm) determined by combustion ion chromatography of the toner and XPS (%) denotes a fluorine content ratio (%) determined by X-ray photoelectron spectroscopic analysis of the toner.

11. An image forming apparatus, comprising:
an electrostatic latent image bearer;
an electrostatic latent image forming unit configured to form an electrostatic latent image on the electrostatic latent image bearer; and
a developing unit containing a toner and configured to develop the electrostatic latent image formed on the electrostatic latent image bearer to form a visible image,
wherein the toner satisfies a ratio XPS (%)/CIC (ppm) of 1.40×10⁻² or less, where CIC (ppm) denotes a fluorine content ratio (ppm) determined by combustion ion chromatography of the toner and XPS (%) denotes a fluorine content ratio (%) determined by X-ray photoelectron spectroscopic analysis of the toner.
